(19) United States
(12) Patent Application Publication
(10) Pub. No.: US 2024/0286934 A1
(43) Pub. Date: Aug. 29, 2024

(54) ACIDIC AND ALKALINE CLEANING OF ION EXCHANGE SYSTEMS, SUCH AS WATER PURIFIERS, BY ION EXCHANGE RESIN

(71) Applicant: GAMBRO LUNDIA AB, Lund (SE)

(72) Inventors: Carl-Henry ÖRNDAL, Eslöv (SE); Sophie SANDBLAD, Lund (SE); Peter SENDELIUS, Staffanstorp (SE); Markus NILSSON, Lund (SE)

(21) Appl. No.: 18/572,121

(22) PCT Filed: Jun. 1, 2022
(86) PCT No.: PCT/EP2022/064891

§ 371 Date: Dec. 19, 2023

(30) Foreign Application Priority Data
Jun. 22, 2021 (SE) 2150800-7

(51) Int. Cl. C02F 1/42; B01J 49/53; B01J 49/57; C02F 1/00

(52) U.S. Cl. CPC C02F 1/42; B01J 49/53; B01J 49/57; C02F 1/008; C02F 2001/422; C02F 2001/425; C02F 2001/427

(57) ABSTRACT

A water purification module includes a fluid path and a control unit. The flow path includes a cationic resin cartridge, an anionic resin cartridge in fluid communication with the cationic resin cartridge, and at least one bypass fluid path arranged to bypass one of the cationic resin cartridge and the anionic resin cartridge, while allowing water to flow to the other of the cationic resin cartridge and the anionic resin cartridge. The flow path also includes a valve arrangement comprising one or more valves configured to selectively direct water to the at least one bypass fluid path. The control unit is configured to control the valve arrangement to direct water to the at least one bypass fluid path based on a production mode of the water purification module.

### BACKGROUND

The present disclosure relates generally to water purification systems (e.g., water purifiers) including ion exchange resin. Water purification systems may be used to purify feed water, which may be contaminated by a variety of solutes, suspended compounds and hardness species. For example, for certain applications or uses, hard feed water (e.g., water with a high content of calcium and/or magnesium) increases the risk of scaling in components downstream of the water purifier (e.g., an ion exchange water purifier) thereby increasing the likelihood of those components requiring maintenance or service, which causes disruption in water purification. Other sources of contamination that lead to fouling may be from iron, silica, clay and other organic matter. The feed water may be treated by removing specific ion species (e.g., hardness ion species) with a water purifier. Cleaning a water purifier's fluid path, especially the portion of the fluid path downstream from the purification process (e.g., ion exchange), is regularly performed on most water purification systems. For example, cleaning may be performed on a regular basis to maintain the performance and reliability of the water device. Depending on the feed water quality and intended purpose or use of the product water, different cleaning technologies and approaches may be used.

Heat disinfection may be used to disinfect and clean a water path. For example, heat disinfection may prevent biofilm(s) from forming along a water line or path that exists within the water purification system. However, while heat disinfection is effective to prevent organic fouling, the heat disinfection process is less effective at preventing scaling and in some instances may increase scaling as hardness species have less solubility in water with higher temperatures. Furthermore, heat disinfection may be ineffective at treating biofilm(s) that are already present in a water line. Due to the limitations of heat disinfection, cleaning may also be achieved using chemicals to clean the water line.

Typically, cleaning is achieved by adding chemicals (either acidic or alkaline, such as an anti-scalant) to the water line or path that exists within the water purification system. For example, an end-user or service provider may add chemicals into a water purification system (e.g., water purifier), such that the chemicals pass through the water purifier's fluid path to remove fouling and/or scaling. Fouling and scaling typically occur where particles or solutes present in feed water are deposited onto corresponding surfaces or within pores of the water purifier components (e.g., membranes, filters, water lines, etc.). Additionally, fouling and scaling may degrade or significantly reduce the function of membranes, filters and water lines. Furthermore, fouling and scaling may lead to increases in energy requirements for the water purifier due to reduced flow across filters, across membranes, and through water lines. The reduced flow may require higher pressures to produce the same volume of product water. Left untreated, feed water may produce irreversible scaling and fouling thereby reducing the life of various components of the water purifier (e.g., filters, membranes, water lines, etc.).

As noted above, fouling and scaling is a common problem with water purification systems (e.g., water purifiers), which may generally be referred to as a water device(s). In order to maintain the water purifier and ensure optimum performance of the device, regular maintenance is required to combat fouling and scaling. The maintenance typically involves chemical cleaning or replacement of the degraded components (e.g., filters, membranes, water lines, etc.).

However, chemical cleaning processes often result in excessive downtime and require the use of toxic chemicals and anti-scalants. The chemicals may be stored in a canister near the water device (e.g., standing beside the water device) to add to the fluid path as needed. However, adding concentrated chemicals to achieve cleaning typically requires an operator (e.g., clinician, home user, operator at a facility, etc.) to use protective gear when adding the cleaning chemicals to the system. Additionally, using cleaning solutions typically requires additional training and procedures for handling and application of the cleaning chemicals. Furthermore, the cleaning methods described above often increase the size of the water device, which requires an additional compartment or canister to store the chemicals. The increased size and additional compartment for storing the chemicals also reduces the aesthetics of the water device.

There is also a need for a water device that reduces the likelihood of fouling and scaling while eliminating the need for expensive cleaning processes that use chemicals and anti-scalants thereby requiring the operator to wear additional protective gear.

For each of the above reasons, it is desirable to provide an improved water purifier capable of performing cleaning processes (e.g., acid cleaning and alkaline cleaning) to reduce fouling and scaling without the use of chemicals.

### SUMMARY

The present disclosure relates to acid and alkaline cleaning of ion exchange systems, such as water purifiers, by ion exchange resin.

Aspects of the subject matter described herein may be useful alone or in combination with one or more other aspects described herein. In light of the disclosure herein and without limiting the disclosure in any way, in an aspect of the present disclosure, a water purification module includes a fluid path and a control unit. The flow path includes a cationic resin cartridge, an anionic resin cartridge in fluid communication with the cationic resin cartridge, and at least one bypass fluid path arranged to bypass one of the cationic resin cartridge and the anionic resin cartridge, while allowing water to flow to the other of the cationic resin cartridge and the anionic resin cartridge. The flow path also includes a valve arrangement comprising one or more valves configured to selectively direct water to the at least one bypass fluid path. The control unit is configured to control the valve arrangement to direct water to the at least one bypass fluid path based on a production mode of the water purification module.

In another aspect of the present disclosure, which may be used in combination with any other aspect or combination of aspects listed herein, the at least one bypass fluid path includes one of (i) a first bypass fluid path arranged to bypass the anionic resin cartridge while allowing water to flow to the cationic resin cartridge, (ii) a second bypass fluid path arranged to bypass the cationic resin cartridge while allowing water to flow to the anionic resin cartridge, or (iii) a first bypass fluid path arranged to bypass the anionic resin cartridge while allowing water to flow to the cationic resin cartridge and a second bypass fluid path arranged to bypass the cationic resin cartridge while allowing water to flow to the anionic resin cartridge.

In another aspect of the present disclosure, which may be used in combination with any other aspect or combination of aspects listed herein, the production mode is one of (i) a water production mode where the module is configured to generate purified water, (ii) an acid cleaning mode where the module is configured to selectively generate an acid cleaning fluid adapted to remove scaling and perform acid cleaning, and (iii) an alkaline cleaning mode where the module is configured to selectively generate an alkaline cleaning fluid that is adapted to remove at least one of fouling and a biofilm and that is further adapted to perform alkaline cleaning.

In another aspect of the present disclosure, which may be used in combination with any other aspect or combination of aspects listed herein, the anionic resin cartridge is fluidly connected in series with the cationic resin cartridge.

In another aspect of the present disclosure, which may be used in combination with any other aspect or combination of aspects listed herein, the valve arrangement is configured to selectively direct water to the first bypass fluid path of the at least one bypass fluid path.

In another aspect of the present disclosure, which may be used in combination with any other aspect or combination of aspects listed herein, the control unit is configured to control the valve arrangement to selectively direct water through the cationic resin cartridge and to the first bypass fluid path to bypass the anionic resin cartridge in the acid cleaning mode.

In another aspect of the present disclosure, which may be used in combination with any other aspect or combination of aspects listed herein, the first bypass fluid path comprises a first fluid line fluidly connected between a first point and a second point. The first point is downstream from the cationic resin cartridge and upstream from the anionic resin cartridge. The second point is downstream of the anionic resin cartridge.

In another aspect of the present disclosure, which may be used in combination with any other aspect or combination of aspects listed herein, the valve arrangement comprises one or more first valves arranged along the first fluid line.

In another aspect of the present disclosure, which may be used in combination with any other aspect or combination of aspects listed herein, the valve arrangement is configured to selectively direct water to the second bypass fluid path instead of the first bypass fluid path.

In another aspect of the present disclosure, which may be used in combination with any other aspect or combination of aspects listed herein, the control unit is configured to control the valve arrangement to selectively direct water through the second bypass fluid path to bypass the cationic resin cartridge and through the anionic resin cartridge in the alkaline cleaning mode.

In another aspect of the present disclosure, which may be used in combination with any other aspect or combination of aspects listed herein, the second bypass fluid path comprises a second fluid line fluidly connected between a third point and a fourth point. The third point is upstream from both the cationic resin cartridge and the anionic resin cartridge. The fourth point is downstream of the cationic resin cartridge and upstream from the anionic resin cartridge.

In another aspect of the present disclosure, which may be used in combination with any other aspect or combination of aspects listed herein, the valve arrangement comprises one or more second valves arranged along the second fluid line.

In another aspect of the present disclosure, which may be used in combination with any other aspect or combination of aspects listed herein, the fluid path comprises a third fluid line connecting an output port of the cationic resin cartridge to an input port of the anionic resin cartridge.

In another aspect of the present disclosure, which may be used in combination with any other aspect or combination of aspects listed herein, the valve arrangement comprises one or more third valves arranged to stop water flow in the third fluid line while water is directed to the first bypass fluid path.

In another aspect of the present disclosure, which may be used in combination with any other aspect or combination of aspects listed herein, the fluid path comprises a mixed bed resin cartridge in fluid communication with the cationic resin cartridge and the anionic resin cartridge.

In another aspect of the present disclosure, which may be used in combination with any other aspect or combination of aspects listed herein, the mixed bed resin cartridge is arranged downstream and in series with the cationic resin cartridge and the anionic resin cartridge.

In another aspect of the present disclosure, which may be used in combination with any other aspect or combination of aspects listed herein, the first bypass fluid path is arranged to bypass the mixed bed resin cartridge.

In another aspect of the present disclosure, which may be used in combination with any other aspect or combination of aspects listed herein, the first bypass fluid path comprises a fourth fluid line fluidly connected between a fifth point and a second point. The fifth point is downstream of each of the cationic resin cartridge, the anionic resin cartridge and the mixed bed resin cartridge. The second point is downstream of the anionic resin cartridge and upstream from the mixed bed resin cartridge.

In another aspect of the present disclosure, which may be used in combination with any other aspect or combination of aspects listed herein, the mixed bed resin cartridge includes a combination of anion and cation resins.

In another aspect of the present disclosure, which may be used in combination with any other aspect or combination of aspects listed herein, the valve arrangement is configured to direct water to both the cationic resin cartridge and the anionic resin cartridge in the water production mode.

In another aspect of the present disclosure, which may be used in combination with any other aspect or combination of aspects listed herein, the module is configured and arranged to produce a cleaning fluid and clean a portion of the fluid path, that is downstream of both the cationic resin cartridge and the anionic resin cartridge, using the cleaning fluid.

In another aspect of the present disclosure, which may be used in combination with any other aspect or combination of aspects listed herein, the cleaning fluid is one of (i) an acid cleaning fluid that is configured to remove scaling and perform acid cleaning and (ii) an alkaline cleaning fluid that is configured to remove at least one of fouling and a biofilm and that is further configured to perform alkaline cleaning.

In another aspect of the present disclosure, which may be used in combination with any other aspect or combination of aspects listed herein, the acid cleaning fluid is generated by directing water (i) through the cationic resin cartridge and (ii) through the first bypass fluid path to bypass the anionic resin cartridge.

In another aspect of the present disclosure, which may be used in combination with any other aspect or combination of aspects listed herein, the alkaline cleaning fluid is generated by directing water (i) through the second bypass fluid path to bypass the cationic resin cartridge and (ii) through the anionic resin cartridge.

In another aspect of the present disclosure, which may be used in combination with any other aspect or combination of aspects listed herein, the cationic resin cartridge is upstream of the anionic resin cartridge.

In another aspect of the present disclosure, which may be used in combination with any other aspect or combination of aspects listed herein, the cationic resin cartridge is downstream from the anionic resin cartridge.

In another aspect of the present disclosure, which may be used in combination with any other aspect or combination of aspects listed herein, the water purification module further includes a sensor arrangement. The sensor arrangement includes at least one of an upstream conductivity sensor positioned upstream of both the cationic resin cartridge and the anionic resin cartridge, a downstream conductivity sensor and a downstream pH sensor.

In another aspect of the present disclosure, which may be used in combination with any other aspect or combination of aspects listed herein, the module is configured to generate a cleaning fluid when the water purification module is in one of an acid cleaning mode and an alkaline cleaning mode, generate purified water when the water purification module is in a water production mode, and obtain or measure at least one of a conductivity value of the water, a pH value of the cleaning fluid, a conductivity value of the cleaning fluid, and a conductivity value of generated purified water after the cleaning fluid has been generated, using at least one sensor of the sensor arrangement.

In another aspect of the present disclosure, which may be used in combination with any other aspect or combination of aspects listed herein, the module is configured to verify a property of the cleaning fluid based on at least one of: the conductivity value of the water, the pH value, the conductivity value of the cleaning fluid, and the conductivity value of the purified water.

In another aspect of the present disclosure, which may be used in combination with any other aspect or combination of aspects listed herein, the module is configured to verify the property of the cleaning fluid based on at least one of a comparison of the conductivity value of the water with one or more inlet conductivity thresholds, a comparison of the measured pH value or a calculated pH value with one or more pH thresholds. The calculated pH value is calculated from an ionic strength of the cleaning fluid that is based on the conductivity value of the cleaning fluid, a comparison of the conductivity value of the purified water with one or more purified water conductivity thresholds, and a comparison of the conductivity value of the cleaning fluid with the conductivity value of the water.

In another aspect of the present disclosure, which may be used in combination with any other aspect or combination of aspects listed herein, the module is configured to clean a portion of the fluid path that is downstream of both the cationic resin cartridge and the anionic resin cartridge with the cleaning fluid for a specified duration. The cleaning fluid is configured to remove at least one of scaling and a biofilm.

In another aspect of the present disclosure, which may be used in combination with any other aspect or combination of aspects listed herein, the specified duration is based on a result of the verification.

In another aspect of the present disclosure, which may be used in combination with any other aspect or combination of aspects listed herein, the module is configured to measure at least one of a conductivity value and a pH value of the cleaning fluid. Additionally, the module is configured to clean a portion of the fluid path that is downstream of both the cationic resin cartridge and the anionic resin cartridge with the cleaning fluid for a specified duration. The cleaning fluid is configured to remove at least one of scaling and a biofilm.

In another aspect of the present disclosure, which may be used in combination with any other aspect or combination of aspects listed herein, the specified duration is based on at least one of the conductivity value and the pH value of the cleaning fluid.

In another aspect of the present disclosure, which may be used in combination with any other aspect or combination of aspects listed herein, the water purification module further includes an upstream conductivity sensor that is positioned upstream of both the cationic resin cartridge and the anionic resin cartridge.

In another aspect of the present disclosure, which may be used in combination with any other aspect or combination of aspects listed herein, the module is configured to measure an upstream conductivity of water with an upstream conductivity sensor, measure a downstream conductivity of the cleaning fluid with a downstream conductivity sensor, and calculate a performance ratio of at least one of the cationic resin cartridge and the anionic resin cartridge based on the conductivity measured from the upstream conductivity sensor and the downstream conductivity sensor.

In another aspect of the present disclosure, which may be used in combination with any other aspect or combination of aspects listed herein, the performance ratio is based on the downstream conductivity divided by the upstream conductivity.

In another aspect of the present disclosure, which may be used in combination with any other aspect or combination of aspects listed herein, the performance ratio is one of a purified water conductivity ratio, an acid cleaning fluid conductivity ratio, and an alkaline cleaning fluid conductivity ratio.

In another aspect of the present disclosure, which may be used in combination with any other aspect or combination of aspects listed herein, the module is configured to compare the performance ratio to a threshold value.

In another aspect of the present disclosure, which may be used in combination with any other aspect or combination of aspects listed herein, the module is configured to provide an alert indicating a status of at least one of the cationic resin cartridge and the anionic resin cartridge. The status is related to a remaining life of at least one of the cationic resin cartridge and the anionic resin cartridge.

In another aspect of the present disclosure, which may be used in combination with any other aspect or combination of aspects listed herein, the remaining life is based, at least in part, on a respective conductivity of the cleaning fluid.

In another aspect of the present disclosure, which may be used in combination with any other aspect or combination of aspects listed herein, an upstream pH sensor is positioned upstream of both the cationic resin cartridge and the anionic resin cartridge. The downstream pH sensor is positioned downstream of both the cationic resin cartridge and the anionic resin cartridge.

In another aspect of the present disclosure, which may be used in combination with any other aspect or combination of aspects listed herein, the module is configured to determine at least one of a conductivity value and an estimated pH value of the cleaning fluid. The estimated pH value of the cleaning fluid is based on an ionic strength of the cleaning fluid.

In another aspect of the present disclosure, which may be used in combination with any other aspect or combination of aspects listed herein, the conductivity value is related to the ionic strength of the cleaning fluid.

In another aspect of the present disclosure, which may be used in combination with any other aspect or combination of aspects listed herein, the estimated pH value is based on at least one of a conductivity of the cleaning fluid and an ionic strength of the cleaning fluid.

In another aspect of the present disclosure, which may be used in combination with any other aspect or combination of aspects listed herein, the module is configured to evaluate a performance of at least one of the cationic resin cartridge and the anionic resin cartridge based on at least one of a comparison of the conductivity value of the purified water with one or more purified water thresholds, a comparison of the measured pH value or a calculated pH value with one or more pH performance thresholds, and a comparison of the conductivity value of the cleaning fluid or purified water with the conductivity value of the inlet water. The calculated pH value is calculated from an ionic strength of the cleaning fluid that is based on the conductivity value of the cleaning fluid.

In another aspect of the present disclosure, which may be used in combination with any other aspect or combination of aspects listed herein, the module is configured to provide an alert indicative of a result of the verification and/or result of the evaluation of the performance of the at least one of the cationic resin cartridge and the anionic resin cartridge.

In another aspect of the present disclosure, which may be used in combination with any other aspect or combination of aspects listed herein, the cationic resin cartridge includes a strong cationic resin sub-cartridge and/or a weak cationic resin sub-cartridge.

In another aspect of the present disclosure, which may be used in combination with any other aspect or combination of aspects listed herein, the strong cationic resin sub-cartridge includes a cationic ion exchange resin in an H-form.

In another aspect of the present disclosure, which may be used in combination with any other aspect or combination of aspects listed herein, the weak cationic resin sub-cartridge includes a cationic ion exchange resin in an H-form.

In another aspect of the present disclosure, which may be used in combination with any other aspect or combination of aspects listed herein, the anionic resin cartridge includes a strong anionic resin sub-cartridge and/or a weak anionic resin sub-cartridge.

In another aspect of the present disclosure, which may be used in combination with any other aspect or combination of aspects listed herein, the strong anionic resin sub-cartridge includes an anionic ion exchange resin in an OH-form.

In another aspect of the present disclosure, which may be used in combination with any other aspect or combination of aspects listed herein, the weak anionic resin sub-cartridge includes an anionic ion exchange resin in an OH-form.

In another aspect of the present disclosure, which may be used in combination with any other aspect or combination of aspects listed herein, the water purification module further includes a pre-treatment module. The pre-treatment module includes at least one of a water softener, an active carbon filter, a particle filter, and an ultraviolet sterilizer.

In another aspect of the present disclosure, which may be used in combination with any other aspect or combination of aspects listed herein, the pre-treatment module is arranged upstream of the cationic resin cartridge and the anionic resin cartridge.

In another aspect of the present disclosure, which may be used in combination with any other aspect or combination of aspects listed herein, the water purification module further includes a polishing module. The polishing module includes at least one of a mixed bed resin cartridge, an electrodeionization (EDI) module, a continuous electrodeionization module (CEDI), and a fluid membrane.

In another aspect of the present disclosure, which may be used in combination with any other aspect or combination of aspects listed herein, the polishing module is arranged downstream from both the cationic resin cartridge and the anionic resin cartridge.

In another aspect of the present disclosure, which may be used in combination with any other aspect or combination of aspects listed herein, the module is configured to direct water to bypass one of the cationic resin cartridge and the anionic resin cartridge by directing water through the first bypass fluid path that is arranged to bypass the anionic resin cartridge while allowing water to flow to the cationic resin cartridge.

In another aspect of the present disclosure, which may be used in combination with any other aspect or combination of aspects listed herein, the module is configured to direct water to bypass one of the cationic resin cartridge and the anionic resin cartridge by directing water through the second bypass fluid path that is arranged to bypass the cationic resin cartridge while allowing water to flow to the anionic resin cartridge.

In another aspect of the present disclosure, which may be used in combination with any other aspect or combination of aspects listed herein, the at least one bypass fluid path is a first bypass fluid path arranged to bypass the anionic resin cartridge while allowing water to follow to the cationic resin cartridge.

In another aspect of the present disclosure, which may be used in combination with any other aspect or combination of aspects listed herein, the at least one bypass fluid path is a second bypass fluid path arranged to bypass the cationic resin cartridge while allowing water to flow to the anionic resin cartridge.

In another aspect of the present disclosure, which may be used in combination with any other aspect or combination of aspects listed herein, the at least one bypass fluid path is a first bypass fluid path and a second bypass fluid path.

Aspects of the subject matter described herein may be useful alone or in combination with one or more other aspects described herein. In an aspect of the present disclosure, a solution generation system includes a water purification module according to any one of the preceding claims and a solution generation module comprising another fluid path fluidly connected to the fluid path of the water purification module. The solution generation module is configured and arranged to receive purified water from the water purification module, and prepare a solution by mixing a concentrate and the purified water.

In another aspect of the present disclosure, which may be used in combination with any other aspect or combination of aspects listed herein, the water purification module is configured to provide a cleaning fluid to the other fluid path for cleaning the other fluid path.

Aspects of the subject matter described herein may be useful alone or in combination with one or more other aspects described herein. In an aspect of the present disclosure, a method for producing a cleaning fluid with a water purification module arranged for producing purified water, where the water purification module includes a cationic resin cartridge and an anionic resin cartridge positioned along a fluid path, includes directing water through at least one bypass fluid path to bypass one of the cationic resin cartridge and the anionic resin cartridge, while directing water to flow to the other of the cationic resin cartridge and the anionic resin cartridge, based on a production mode of the water purification module.

In another aspect of the present disclosure, which may be used in combination with any other aspect or combination of aspects listed herein, the at least one bypass fluid path includes one of (i) a first bypass fluid path arranged to bypass the anionic resin cartridge while allowing water to follow to the cationic resin cartridge, (ii) a second bypass fluid path arranged to bypass the cationic resin cartridge while allowing water to flow to the anionic resin cartridge, or (iii) a first bypass fluid path and a second bypass fluid path.

In another aspect of the present disclosure, which may be used in combination with any other aspect or combination of aspects listed herein, the production mode is one of a water production mode, an acid cleaning mode, and an alkaline cleaning mode.

In another aspect of the present disclosure, which may be used in combination with any other aspect or combination of aspects listed herein, the anionic resin cartridge is fluidly connected in series with the cationic resin cartridge.

In another aspect of the present disclosure, which may be used in combination with any other aspect or combination of aspects listed herein, the method includes directing water to the first bypass fluid path of the at least one bypass fluid path.

In another aspect of the present disclosure, which may be used in combination with any other aspect or combination of aspects listed herein, the method includes controlling a valve arrangement to selectively direct water to the first bypass fluid path of the at least one bypass fluid path in the acid cleaning mode.

In another aspect of the present disclosure, which may be used in combination with any other aspect or combination of aspects listed herein, the first bypass fluid path comprises a first fluid line fluidly connected between a first point and a second point. The first point is downstream from the cationic resin cartridge and upstream from the anionic resin cartridge. The second point is downstream of the anionic resin cartridge.

In another aspect of the present disclosure, which may be used in combination with any other aspect or combination of aspects listed herein, the valve arrangement comprises one or more first valves arranged along the first fluid line.

In another aspect of the present disclosure, which may be used in combination with any other aspect or combination of aspects listed herein, the method includes directing water to the second bypass fluid path instead of the first bypass fluid path.

In another aspect of the present disclosure, which may be used in combination with any other aspect or combination of aspects listed herein, the method includes controlling the valve arrangement to selectively direct water to the second bypass fluid path in the in the alkaline cleaning mode.

In another aspect of the present disclosure, which may be used in combination with any other aspect or combination of aspects listed herein, the second bypass fluid path comprises a second fluid line fluidly connected between a third point and a fourth point. The third point is upstream from both the cationic resin cartridge and the anionic resin cartridge. The fourth point is downstream of the cationic resin cartridge and upstream from the anionic resin cartridge.

In another aspect of the present disclosure, which may be used in combination with any other aspect or combination of aspects listed herein, the valve arrangement comprises one or more second valves arranged along the second fluid line.

In another aspect of the present disclosure, which may be used in combination with any other aspect or combination of aspects listed herein, the fluid path comprises a third fluid line connecting an output port of the cationic resin cartridge to an input port of the anionic resin cartridge.

In another aspect of the present disclosure, which may be used in combination with any other aspect or combination of aspects listed herein, the method includes stopping water flow in the third fluid line while water is directed to the first bypass fluid path.

In another aspect of the present disclosure, which may be used in combination with any other aspect or combination of aspects listed herein, the fluid path comprises a mixed bed resin cartridge in fluid communication with the cationic resin cartridge and the anionic resin cartridge.

In another aspect of the present disclosure, which may be used in combination with any other aspect or combination of aspects listed herein, the mixed bed resin cartridge is arranged downstream and in series with the cationic resin cartridge and the anionic resin cartridge.

In another aspect of the present disclosure, which may be used in combination with any other aspect or combination of aspects listed herein, the first bypass fluid path comprises a fourth fluid line fluidly connected between a fifth point and a second point. The fifth point is downstream of each of the cationic resin cartridge, the anionic resin cartridge and the mixed bed resin cartridge. The second point is downstream of the anionic resin cartridge and upstream from the mixed bed resin cartridge.

In another aspect of the present disclosure, which may be used in combination with any other aspect or combination of aspects listed herein, the mixed bed resin cartridge includes a combination of anion and cation resins.

In another aspect of the present disclosure, which may be used in combination with any other aspect or combination of aspects listed herein, the method includes directing water to both the cationic resin cartridge and the anionic resin cartridge in the water production mode.

In another aspect of the present disclosure, which may be used in combination with any other aspect or combination of aspects listed herein, the method includes cleaning a portion of the fluid path, that is downstream of both the cationic resin cartridge and the anionic resin cartridge, using the cleaning fluid.

In another aspect of the present disclosure, which may be used in combination with any other aspect or combination of aspects listed herein, the cleaning fluid is one of (i) an acid cleaning fluid that is configured to remove scaling and perform acid cleaning and (ii) an alkaline cleaning fluid that is configured to remove at least one of fouling and a biofilm and that is further configured to perform alkaline cleaning.

In another aspect of the present disclosure, which may be used in combination with any other aspect or combination of aspects listed herein, the acid cleaning fluid is generated by directing water (i) through the cationic resin cartridge and (ii) through the first bypass fluid path to bypass the anionic resin cartridge.

In another aspect of the present disclosure, which may be used in combination with any other aspect or combination of aspects listed herein, the alkaline cleaning fluid is generated by directing water (i) through the second bypass fluid path to bypass the cationic resin cartridge and (ii) through the anionic resin cartridge.

In another aspect of the present disclosure, which may be used in combination with any other aspect or combination of aspects listed herein, the cationic resin cartridge and the anionic resin cartridge are connected in series with the cationic resin cartridge upstream of the anionic resin cartridge.

In another aspect of the present disclosure, which may be used in combination with any other aspect or combination of aspects listed herein, the cationic resin cartridge and the anionic resin cartridge are connected in series with the cationic resin cartridge downstream from the anionic resin cartridge.

In another aspect of the present disclosure, which may be used in combination with any other aspect or combination of aspects listed herein, the method includes sensing a property of at least one of the water, the cleaning fluid, and the purified water with a sensor arrangement. The sensor arrangement includes at least one of a downstream temperature sensor, a downstream conductivity sensor and a downstream pH sensor.

In another aspect of the present disclosure, which may be used in combination with any other aspect or combination of aspects listed herein, the method includes obtaining or measuring at least one of a conductivity value of water, a pH value of the cleaning fluid, a conductivity value of the cleaning fluid, and a conductivity value of generated purified water after the cleaning fluid has been generated, using at least one sensor of the sensor arrangement.

In another aspect of the present disclosure, which may be used in combination with any other aspect or combination of aspects listed herein, the method includes verifying a property of the cleaning fluid based on at least one of: the conductivity value of the water, the pH value, the conductivity value of the cleaning fluid, and the conductivity value of the purified water.

In another aspect of the present disclosure, which may be used in combination with any other aspect or combination of aspects listed herein, verifying the property of the cleaning fluid is based on at least one of a comparison of the conductivity value of the water with one or more inlet conductivity thresholds, a comparison of the measured pH value or a calculated pH value with one or more pH thresholds (the calculated pH value is calculated from an ionic strength of the cleaning fluid that is based on the conductivity value of the cleaning fluid), a comparison of the conductivity value of the purified water with one or more purified water conductivity thresholds, and a comparison of the conductivity value of the cleaning fluid with the conductivity value of the water.

In another aspect of the present disclosure, which may be used in combination with any other aspect or combination of aspects listed herein, the method includes cleaning a portion of the fluid path that is downstream of both the cationic resin cartridge and the anionic resin cartridge with the cleaning fluid for a specified duration. The cleaning fluid is configured to remove at least one of scaling and a biofilm.

In another aspect of the present disclosure, which may be used in combination with any other aspect or combination of aspects listed herein, the specified duration is based on a result of the verification.

In another aspect of the present disclosure, which may be used in combination with any other aspect or combination of aspects listed herein, the method includes measuring at least one of a conductivity value and a pH value of the cleaning fluid, and cleaning a portion of the fluid path that is downstream of both the cationic resin cartridge and the anionic resin cartridge with the cleaning fluid for a specified duration. The cleaning fluid is configured to remove at least one of scaling and a biofilm.

In another aspect of the present disclosure, which may be used in combination with any other aspect or combination of aspects listed herein, the specified duration is based on at least one of the conductivity value and the pH value of the cleaning fluid.

In another aspect of the present disclosure, which may be used in combination with any other aspect or combination of aspects listed herein, an upstream conductivity sensor is positioned upstream of both the cationic resin cartridge and the anionic resin cartridge.

In another aspect of the present disclosure, which may be used in combination with any other aspect or combination of aspects listed herein, the method includes measuring an upstream conductivity of water with an upstream conductivity sensor, measuring a downstream conductivity of the cleaning fluid with a downstream conductivity sensor, and calculating a performance ratio of at least one of the cationic resin cartridge and the anionic resin cartridge based on the conductivity measured from the upstream conductivity sensor and the downstream conductivity sensor.

In another aspect of the present disclosure, which may be used in combination with any other aspect or combination of aspects listed herein, the performance ratio is based on the downstream conductivity divided by the upstream conductivity.

In another aspect of the present disclosure, which may be used in combination with any other aspect or combination of aspects listed herein, the performance ratio is one of a purified water conductivity ratio, an acid cleaning fluid conductivity ratio, and an alkaline cleaning fluid conductivity ratio.

In another aspect of the present disclosure, which may be used in combination with any other aspect or combination of aspects listed herein, the method includes comparing the performance ratio to a threshold value.

In another aspect of the present disclosure, which may be used in combination with any other aspect or combination of aspects listed herein, the method includes providing an alert indicating a status of at least one of the cationic resin cartridge and the anionic resin cartridge. The status is related to the remaining life of at least one of the cationic resin cartridge and the anionic resin cartridge.

In another aspect of the present disclosure, which may be used in combination with any other aspect or combination of aspects listed herein, the remaining life is based on a respective conductivity of the cleaning fluid.

In another aspect of the present disclosure, which may be used in combination with any other aspect or combination of aspects listed herein, an upstream pH sensor is positioned upstream of both the cationic resin cartridge and the anionic resin cartridge. The downstream pH sensor is positioned downstream of both the cationic resin cartridge and the anionic resin cartridge.

In another aspect of the present disclosure, which may be used in combination with any other aspect or combination of aspects listed herein, the method includes determining at least one of a conductivity value and an estimated pH value of the cleaning fluid. The estimated pH value of the cleaning fluid is based on an ionic strength of the cleaning fluid.

In another aspect of the present disclosure, which may be used in combination with any other aspect or combination of aspects listed herein, the conductivity value is related to the ionic strength of the cleaning fluid.

In another aspect of the present disclosure, which may be used in combination with any other aspect or combination of aspects listed herein, the estimated pH value is based on at least one of a conductivity of the cleaning fluid and an ionic strength of the cleaning fluid.

In another aspect of the present disclosure, which may be used in combination with any other aspect or combination of aspects listed herein, the method includes evaluating a performance of at least one of the cationic resin cartridge and the anionic resin cartridge based on at least one of a comparison of the conductivity value of the purified water with one or more purified water thresholds, a comparison of the measured pH value or a calculated pH value with one or more pH performance thresholds (the calculated pH value is calculated from an ionic strength of the cleaning fluid that is based on the conductivity value of the cleaning fluid), and a comparison of the conductivity value of the cleaning fluid or purified water with the conductivity value of the water.

In another aspect of the present disclosure, which may be used in combination with any other aspect or combination of aspects listed herein, the method includes providing an alert indicative of a result of the verification and/or result of the evaluation of the performance of the at least one of the cationic resin cartridge and the anionic resin cartridge.

In another aspect of the present disclosure, which may be used in combination with any other aspect or combination of aspects listed herein, the cationic resin cartridge includes a strong cationic resin sub-cartridge and/or a weak cationic resin sub-cartridge.

In another aspect of the present disclosure, which may be used in combination with any other aspect or combination of aspects listed herein, the strong cationic resin sub-cartridge includes a cationic ion exchange resin in an H-form.

In another aspect of the present disclosure, which may be used in combination with any other aspect or combination of aspects listed herein, the weak cationic resin sub-cartridge includes a cationic ion exchange resin in an H-form.

In another aspect of the present disclosure, which may be used in combination with any other aspect or combination of aspects listed herein, the anionic resin cartridge includes a strong anionic resin sub-cartridge and a weak anionic resin sub-cartridge.

In another aspect of the present disclosure, which may be used in combination with any other aspect or combination of aspects listed herein, the strong anionic resin sub-cartridge includes an anionic ion exchange resin in an OH-form.

In another aspect of the present disclosure, which may be used in combination with any other aspect or combination of aspects listed herein, the weak anionic resin sub-cartridge includes an anionic ion exchange resin in an OH-form.

In another aspect of the present disclosure, which may be used in combination with any other aspect or combination of aspects listed herein, the method includes, prior to directing the water to bypass one of the resin cartridges, pretreating the water in a pre-treatment module. The pre-treatment module includes at least one of a water softener, an active carbon filter, a particle filter, and an ultraviolet sterilizer.

In another aspect of the present disclosure, which may be used in combination with any other aspect or combination of aspects listed herein, the pre-treatment module is arranged upstream of the cationic resin cartridge and the anionic resin cartridge.

In another aspect of the present disclosure, which may be used in combination with any other aspect or combination of aspects listed herein, the method includes, after directing the water to bypass one of the resin cartridges, polishing the cleaning fluid with a polishing module. The polishing module includes at least one of a mixed bed resin cartridge, an electrodeionization (EDI) module, a continuous electrodeionization module (CEDI), and a fluid membrane.

In another aspect of the present disclosure, which may be used in combination with any other aspect or combination of aspects listed herein, the polishing module is arranged downstream from both the cationic resin cartridge and the anionic resin cartridge.

In another aspect of the present disclosure, which may be used in combination with any other aspect or combination of aspects listed herein, the method includes directing water to bypass one of the cationic resin cartridge and the anionic resin cartridge includes directing water through the first bypass fluid path that is arranged to bypass the anionic resin cartridge while allowing water to flow to the cationic resin cartridge.

In another aspect of the present disclosure, which may be used in combination with any other aspect or combination of aspects listed herein, directing water to bypass one of the cationic resin cartridge and the anionic resin cartridge includes directing water through the second bypass fluid path that is arranged to bypass the cationic resin cartridge while allowing water to flow to the anionic resin cartridge.

In another aspect of the present disclosure, which may be used in combination with any other aspect or combination of aspects listed herein, the at least one bypass fluid path is a first bypass fluid path arranged to bypass the anionic resin cartridge while allowing water to follow to the cationic resin cartridge.

In another aspect of the present disclosure, which may be used in combination with any other aspect or combination of aspects listed herein, the at least one bypass fluid path is a second bypass fluid path arranged to bypass the cationic resin cartridge while allowing water to flow to the anionic resin cartridge.

In another aspect of the present disclosure, which may be used in combination with any other aspect or combination of aspects listed herein, the at least one bypass fluid path is a first bypass fluid path and a second bypass fluid path.

In another aspect of the present disclosure, which may be combined with any other aspect listed herein unless specified otherwise, any of the features, functionality and alternatives described in connection with any one or more of FIGS. 1A-1C, FIG. 2, FIG. 3 and FIG. 4 may be combined with any of the features, functionality and alternatives described in connection with any other of FIGS. 1 to 4.

It is accordingly an advantage of the present disclosure to provide a water purification device capable of performing one or both of acidic cleaning and alkaline cleaning with the same ion exchange resin cartridges used to purify water.

It is another advantage of the present disclosure to provide a water purification device capable of performing one or both of acidic cleaning and alkaline cleaning without the addition of cleaning chemicals or solutions to the system.

It is another advantage of the present disclosure to provide a water purification device capable of performing one or more of water production, acid cleaning, alkaline cleaning, resin saving, and producing water with certain pH characteristics (e.g., water with a tuned pH).

It is yet another advantage of the present disclosure to prepare an initial cleaning fluid from the existing ion exchange resin cartridges of the system.

It is a further advantage of the present disclosure to provide a water purification device that can provide purified water as well as cleaning fluids (e.g., acid cleaning fluid and alkaline cleaning fluid) to downstream devices, such as a solution generation system that mixes product water with concentrates.

It is another advantage of the present disclosure to minimize the quantity of user interactions with the system by minimizing the frequency and quantity of resin cartridges to be changed during a given time period for a given feed water composition.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1A is a block diagram of a water purification module in a water production mode according to an example of the present disclosure.

FIG. 1B is a block diagram of a water purification module in an acid cleaning mode according to an example of the present disclosure.

FIG. 1C is a block diagram of a water purification module in an alkaline cleaning mode according to an example of the present disclosure.

FIG. 2 is a block diagram of an alternate water purification module according to an example of the present disclosure.

FIG. 3 is a block diagram of a solution generation system according to an example of the present disclosure.

FIG. 4 is a flowchart of an example process for generating at least one of purified water, an acid cleaning fluid, and an alkaline cleaning fluid with a water purification module according to an example of the present disclosure.

### DETAILED DESCRIPTION

Ion exchange systems, such as water purifiers or water devices, may be used to purify feed water. Additionally, ion exchange systems may be used to clean a portion of a fluid path that is downstream from the water purification step (e.g., downstream of the ion exchange that purifies the feed water).

The systems, methods and techniques disclosed herein may be used to remove “fouling”, “scaling” and/or “biofilm(s)” from a water line or a water path. The fouling, scaling and/or biofilm(s) may independently or collectively impede or interfere with the function of the water purifier and more specifically the water line downstream of the water purification process. For example, fouling, scaling and/or biofilms may degrade or significantly reduce the function of membranes, filters and water lines. Furthermore, the accumulation of fouling, scaling and/or biofilm(s) may lead to increases in energy requirements for the water purifier due to reduced flow across filters, across membranes, and through water lines. The reduced flow may require higher pressures to produce the same volume of purified product water. Left untreated, feed water may produce irreversible fouling, scaling and/or biofilm(s) thereby reducing the life of various components of the water purifier (e.g., filters, membranes, water lines, etc.

“Fouling” is the accumulation of unwanted material on a surface, and the fouling materials may consist of either living organisms (e.g., biofouling) or non-living substances (e.g., inorganic or organic). Fouling may be from iron, silica, clay and organic matter. Fouling typically occurs where particles or solutes present in feed water are deposited onto corresponding surfaces or within pores of the water purifier components (e.g., membranes, filters, water lines, etc.). Some examples of fouling include microbial growth, algae, and some biofilms.

“Scaling” is the crystallization of solids, such as salts, oxides and hydroxides from water solutions (e.g., calcium carbonate or calcium sulfate). Scaling may also be referred to as precipitation fouling. Some examples of scaling include the precipitation of Magnesium Carbonate (MgCO₃) and Calcium Carbonate (CaCO₃).

“Biofilm” refers to any microorganism where cells stick to each other and often to other surfaces. Even though biofilm(s) include organic matter, the biofilm(s) may also include or form inorganic objects in water. As noted above, some biofilms may be considered a form of fouling.

“Acid cleaning” refers to a low pH solution that is adapted for removing scaling. For example, if feed water is run through a cationic ion exchange resin (e.g., in the H-form), the pH of the feed water will be lowered forming a low pH solution. The resulting low pH solution is adapted for removing scaling through a process called acid cleaning.

“Alkaline cleaning” refers to a high pH solution that is adapted for removing fouling. For example, if feed water is run through an anionic ion exchange resin (e.g., OH-form), the pH of the feed water will be raised forming a high pH solution. The resulting high pH solution is adapted for removing fouling through a process called alkaline cleaning.

According to the systems, methods and techniques described herein, a water purifier may be configured to purify a portion of the fluid path in a water device from scaling, fouling and/or biofilm(s). The ion exchange system (e.g., water purifier) may be used for (i) high quality water production (e.g., conductivity below 1 μS/cm), (ii) acid cleaning, or (iii) alkaline cleaning. Therefore, the ion exchange system may advantageously produce high quality water while also performing both acid and alkaline cleaning without the addition of extra cleaning chemicals. By performing cleaning operations (e.g., acid cleaning and/or alkaline cleaning) through the use of the existing anionic and cationic resin cartridges, the systems and methods disclosed herein advantageously reduces or eliminates the need for a user to handle hazardous and toxic cleaning chemicals. Furthermore, the complexity of the system is reduced since the existing components (e.g., cationic resin cartridges and anionic resin cartridges) are configured to generate cleaning fluids with the water purification device.

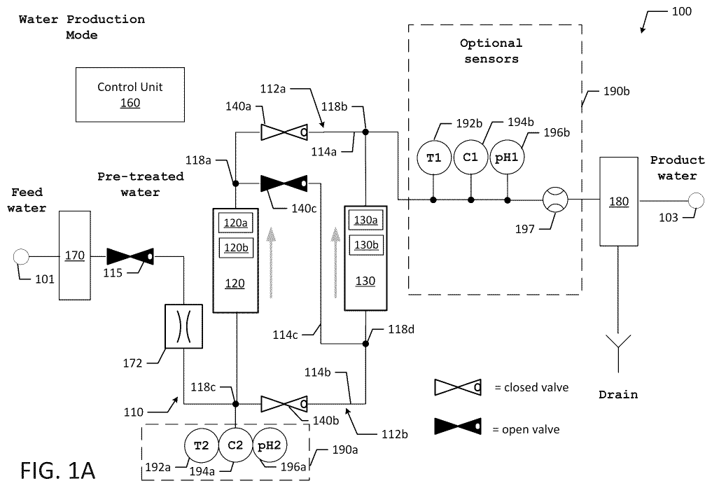

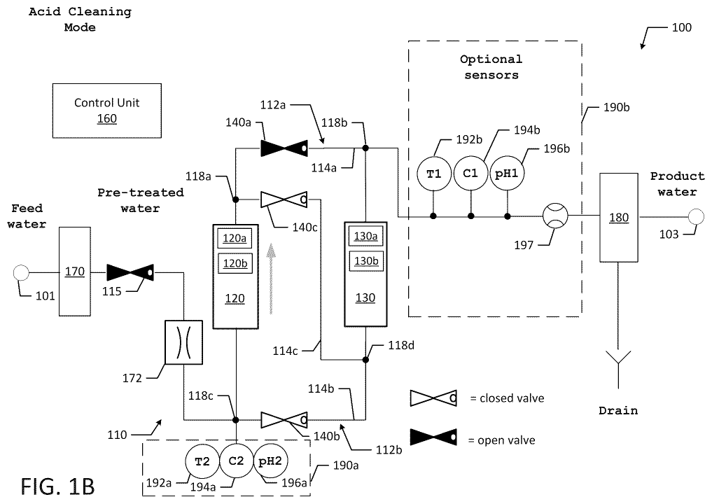

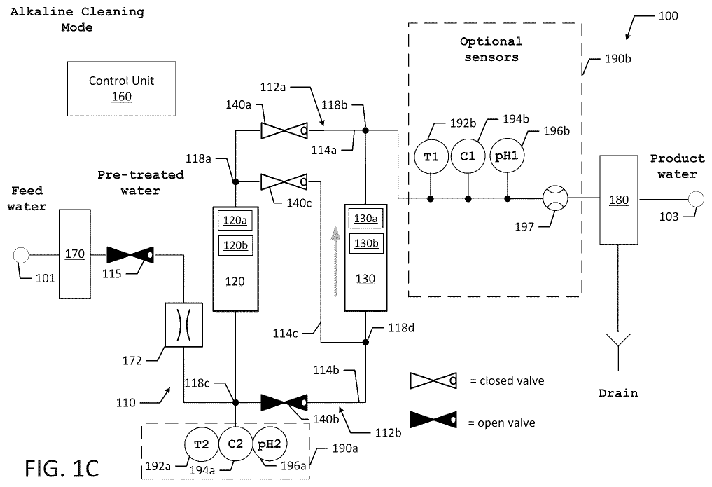

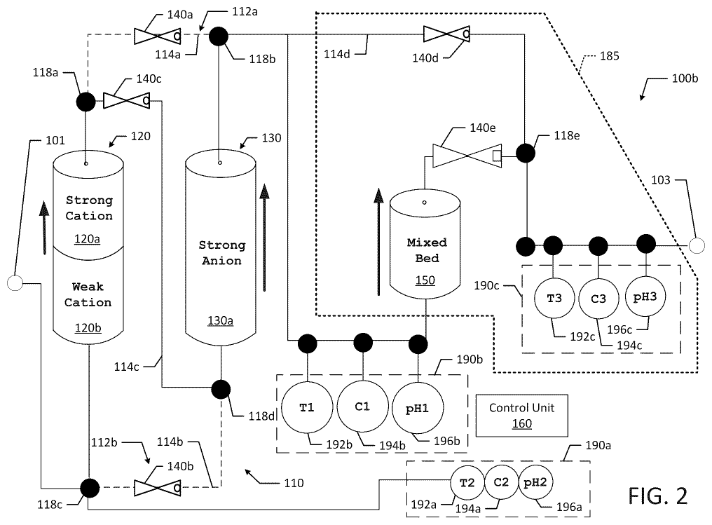

FIGS. 1A, 1B and 1C illustrate a configuration for a water purification module 100a. An alternative configuration for a water purification module 100b is illustrated in FIG. 2. As used herein, water purification module 100a and water purification module 100b may be generally referred to herein as water purification module 100. Referring back to FIGS. 1A, 1B and 1C, water purification module 100a (generally referred to as water purification module 100) includes a fluid path 110 with a cationic resin cartridge 120 and an anionic resin cartridge 130 in fluid communication with the cationic resin cartridge 120. The fluid path 110 may also include at least one bypass fluid path (e.g., bypass fluid paths 112a, 112b). The at least one bypass fluid path is arranged to bypass either the cationic resin cartridge 120 or the anionic resin cartridge 130 while allowing water to flow to the other of the cationic resin cartridge 120 and the anionic resin cartridge 130.

It should be appreciated that the fluid path 110 described herein may be incorporated into other water purification systems. For example, a mixed bed, one or more reverse osmosis (“RO”) membranes or one or more additional polishing steps may optionally be included along the fluid path 110 to further enhance water quality or to achieve higher levels of cleaning. The optional components (e.g., mixed bed, RO membranes, or polishing steps) may be positioned upstream and/or downstream based on functionality of the component. For example, RO membranes may be positioned upstream of the resin cartridges 120, 130 (e.g., ion exchange system) thereby allowing the resin cartridges to be used for polishing after water passes through the RO membranes. Some of these options are described in more detail below.

Resin cartridges 120, 130 may form an ion exchange system for the water purification module 100. Each resin cartridge may be an ion exchange bed where ions become ionically bound to oppositely-charged ionic species in the ion exchange bed. In an example, the ion exchange beds (e.g., resin cartridges 120, 130) may include ion exchange resins, such as cation resins and anion resins. The resins may include a plurality of resin beads. For example, the cationic resin cartridge 120 may include a plurality of cation exchange resin beads while the anionic resin cartridge 130 includes a plurality of anion exchange resin beads. Typically, cationic components of the feed water are attracted to the cation exchange resin beads while anionic components of the feed water are attracted to the anion exchange resin beads.

In each illustrated example of FIGS. 1A, 1B, 1C and FIG. 2, the fluid path 110 starts at a source 101 of feed water and ultimately terminates at an exit 103 (e.g., where product water or a cleaning fluid leaves the fluid path 110). In each example, water purification module 100 is configured and arranged to produce either purified water or a cleaning fluid. When producing a cleaning fluid, water purification module 100 is adapted to clean a portion of the fluid path 110 that is downstream of at least one of cationic resin cartridge 120 and anionic resin cartridge 130 using the cleaning fluid. The water purification module 100 may optionally include a flow meter 197 positioned along the fluid path to measure mass or volumetric flow rates. In the examples illustrated in FIGS. 1A-1C, the flow meter 197 is positioned upstream of polishing module 180, however it should be appreciated that the flow meter 197 may be positioned along any portion of the fluid path 110. Additionally, water purification module 100 may include multiple flow meters 197 positioned along the fluid path 110.

In an example, anionic resin cartridge 130 is fluidly connected in series with cationic resin cartridge 130. As illustrated in FIGS. 1A-1C, cationic resin cartridge 120 is illustrated upstream the anionic resin cartridge 130. Alternatively, the position of each cartridge 120,130 may be flipped such that anionic resin cartridge 130 is upstream cationic resin cartridge 120. In an example, cationic resin cartridge 120 may include demineralization cationic resin(s). Additionally, cationic resin cartridge 120 may include a strong cationic resin sub-cartridge 120a, a weak cationic resin sub-cartridge 120b, or both the strong cationic resin sub-cartridge 120a and the weak cationic resin sub-cartridge 120b. It should be appreciated that the sub-cartridges 120a and/or 120b may collectively form the cationic resin cartridge 120. Alternatively, the cationic resin cartridge 120 may be made up of a single sub-cartridge (e.g., strong cationic sub-cartridge 120a). In more detail, the strong cationic resin sub-cartridge 120a includes a strong cationic exchange resin in an H-form. Additionally, in more detail, the weak cationic resin sub-cartridge 120b may include a weak cationic ion exchange resin in an H-form. Cationic ion exchange resins in the H-form may exchange all other cations for H⁺. For example, Ca²⁺, Mg²⁺, Na⁺ and K⁺ may be exchanged for H⁺. In an example, the cationic resins may have a capacity between 1.8 to 4.5 eq/l. Typically, the pH of the fluid exiting the cationic resin cartridge 120 will be an acidic solution with a pH in the range of 2 to 3 if the water fed to the cationic resin cartridge 120 has a low buffer capacity and a pH of around 7. In an example, the acid cleaning fluid resulting from the fluid exiting the cationic resin cartridge 120 may be considered suitable or acceptable when the pH falls within the range of 2 to 3.

Anionic resin cartridge 130 may include demineralization anionic resin(s). Similarly to cationic resin cartridge 120, anionic resin cartridge 130 may include a strong anionic resin sub-cartridge 130a, a weak anionic resin sub-cartridge 130b, or both the strong anionic resin sub-cartridge 130a and the weak anionic resin sub-cartridge 130b. Similar to above, the sub-cartridges 130a,b may collectively or individually form the anionic resin cartridge 130. In more detail, the strong anionic resin sub-cartridge 130a includes an anionic ion exchange resin in an OH-form. Additionally, in more detail, the weak anionic resin sub-cartridge 130b may include an anionic ion exchange resin in an OH-form. Anionic ion exchange resins in the OH-form may exchange all other anions for OH⁻. For example, SO₄²⁻, NO₃⁻, and Cl⁻ may be exchanged for OH⁻. In an example, the anionic resins may typically have a capacity of approximately 1.0 eq/l. When water passes through the anionic resin cartridge 130, the anionic resin(s) cause a pH change in the water. Typically, the pH of the fluid exiting the anionic resin cartridge 130 will be an alkaline solution with a pH between 11 to 12 if the water fed to the anionic resin cartridge 130 has a low buffer capacity and a pH of around 7. In an example, the alkaline cleaning fluid resulting from the fluid exiting the anionic resin cartridge 130 may be considered suitable or acceptable when the pH falls within the range of 11 to 12.

The combination of the cationic resin cartridge 120 and the anionic resin cartridge 130 results in pure water. For example, passing feed water through both resin cartridges in series 120, 130 results in pure water (e.g., H⁺+OH⁻→H₂O).

Due to the lower capacity of the anionic resins, a balanced system may require a larger anionic resin volume. For example, more anionic resin may be required such that the anionic resin cartridge 130 has the same or similar capacity as the cationic resin cartridge 120. However, by using cleaning fluid (e.g., acid cleaning fluid) that has only been treated with the cationic resin cartridge 120 for some cleaning such as flushing Ultra filters and/or flushing flow paths may help further balance the system thereby requiring less anionic resin. For example, other existing solutions may use the same volume of both resin types (e.g., cationic and anionic), which increases the burden to the patient by requiring frequent cartridge changes as the anionic resin cartridges 130 are often spent well before the cationic resin cartridges 120.

As illustrated in FIG. 1A, bypass fluid path 112a is arranged to bypass the anionic resin cartridge 130 while allowing water to flow through the cationic resin cartridge 120. In more detail, bypass fluid path 112a may be configured and arranged such that water only flows through the cationic resin cartridge 120 while bypassing anionic resin cartridge 130. Similarly, bypass fluid path 112b is arranged to bypass the cationic resin cartridge 120 while allowing water to flow through the anionic resin cartridge 130. In more detail, bypass fluid path 112b may be configured and arranged such that water only flows through the anionic resin cartridge 130 while bypassing the cationic resin cartridge 120.

The fluid path 110 may also include a valve arrangement 140 comprising one or more valves (e.g., valves 140a-e, note that valves 140d and 140e are illustrated in FIG. 2) arranged along the fluid path 110. The one or more valves (e.g., valves 140a-e) are configured to selectively direct water to the bypass fluid path(s) 112a,b based on a production mode of the water purification module 100. As described in more detail below, production modes may include a “water production mode” as illustrated in FIG. 1A, an “acid cleaning mode” as illustrated in FIG. 1B, and an “alkaline cleaning mode” as illustrated in FIG. 1C.

As illustrated in FIGS. 1A, 1B and 1C bypass fluid path 112a may include fluid line 114a fluidly connected between a first point 118a and a second point 118b. Fluid line 114a may be referred to as a first fluid line 114a. The first point 118a is downstream from cationic resin cartridge 120 and upstream from anionic resin cartridge 130. Additionally, the second point 118b is downstream of anionic resin cartridge 130. Essentially, fluid line 114a links an exit point (e.g., point 118a) or output port of cationic resin cartridge 120 with the exit point (e.g., point 118b) or output port of anionic resin cartridge 130 such that water may flow through cationic resin cartridge 120 and bypass anionic resin cartridge 130. A first valve(s) 140a is arranged in the bypass fluid path 112a (thus to the fluid line 114a). The first valve 140a may be selectively controlled to either allow (e.g., when the first valve 140a is open) or prevent (e.g., when the first valve 140a is closed) flow through the bypass fluid path 112a. More specifically, the valve arrangement 140 may comprise one or more valves (e.g., valve 140a) arranged along one or more fluid lines (e.g., fluid line 114a).

Bypass fluid path 112b may include fluid line 114b fluidly connected between a third point 118c and a fourth point 118d. Fluid line 114b may be referred to as a second fluid line 114b. The third point 118c is upstream from both cationic resin cartridge 120 and anionic resin cartridge 130. Additionally, the fourth point 118d is downstream of cationic resin cartridge 120 and upstream from anionic resin cartridge 130. Essentially, fluid line 114b links an entrance point (e.g., point 118c) or input port of cationic resin cartridge 120 with the entrance point (e.g., point 118d) or input port of anionic resin cartridge 130 such that water may bypass cationic resin cartridge 120 and flow through anionic resin cartridge 130. A second valve(s) 140b is arranged in the bypass fluid path 112b (thus to the fluid line 114b). The second valve 140b may be selectively controlled to either allow (e.g., when the second valve 140b is open) or prevent (e.g., when the second valve 140b is closed) flow through the bypass fluid path 112b. More specifically, the valve arrangement 140 may comprise one or more valves (e.g., valve 140b) arranged along one or more fluid lines (e.g., fluid line 114b).

The fluid path 110 may also include fluid line 114c fluidly connected between first point 118a and fourth point 118d. Fluid line 114c may be referred to as a third fluid line 114c. Essentially, fluid line 114c links an exit point (e.g., point 118a) or output port of cationic resin cartridge 120 with the entrance point (e.g., point 118d) or input port of anionic resin cartridge 130 such that water may flow through both the cationic resin cartridge 120 and anionic resin cartridge 130. Specifically, fluid line 114c enables water to flow through cationic resin cartridge 120 and anionic resin cartridge in series. A third valve(s) 140c is arranged to the fluid line 114c. The third valve 140c may be selectively controlled to either allow (e.g., when the third valve 140c is open) or prevent (e.g., when the third valve 140c is closed) flow through the fluid line 114c. More specifically, the valve arrangement 140 may comprise one or more valves (e.g., valve 140c) arranged along one or more fluid lines (e.g., fluid line 114c).

In another example (illustrated in FIG. 2, which is described in more detail below), bypass fluid path 112a may include fluid line 114d fluidly connected between a fifth point 118e and the second point 118b. Fluid line 114d may be referred to as a fourth fluid line 114d. The fifth point 118e is downstream of each of cationic resin cartridge 120, anionic resin cartridge 130 and a mixed bed resin cartridge (e.g., mixed bed resin cartridge 150 of FIG. 2). As discussed above, second point 118b is downstream of anionic resin cartridge 130 and upstream from mixed bed resin cartridge 150 (see FIG. 2). Essentially, fluid line 114d links an exit point (e.g., point 118b) or output port of anionic resin cartridge 130 with an exit point (e.g., point 118e) or output port of mixed bed resin cartridge 150 such that water may flow through anionic resin cartridge 130 and bypass mixed bed resin cartridge 150. A fourth valve(s) 140d is arranged in the bypass fluid path 112a (thus to the fluid line 114d). The fourth valve 140d may be selectively controlled to either allow (e.g., when the fourth valve 140d is open) or prevent (e.g., when the fourth valve 140d is closed) flow through the fluid line 114d. It should be appreciated that the examples in FIGS. 1A-1C may also include this arrangement, that is, a mixed bed resin cartridge 150 and a bypass fluid path 112a including a fluid line 114d fluidly connected between a fifth point 118e and the second point 118b, whereby the mixed bed resin cartridge 150 also is bypassed, as explained in connection with FIG. 2.

Additionally, the water purification module 100 may include a control unit 160 that is configured to control the valve arrangement 140 to direct water to bypass fluid path(s) 112a,b. Valve arrangement 140 may be configured to selectively direct water to bypass fluid path 112a or bypass fluid path 112b. Specifically, control unit 160 may be configured to (i) control valve arrangement 140 to selectively direct water to avoid both bypass fluid paths 112a,b thereby directing water to both the cationic resin cartridge 120 and anionic resin cartridge 130 in the “water cleaning mode” (illustrated in FIG. 1A). For example, the control unit 160 may control valve arrangement 140 by closing the first valve 140a, closing the second valve 140b, and opening the third valve 140c. In some embodiments, the control unit 160 is configured to (ii) control valve arrangement 140 to selectively direct water through cationic resin cartridge 120 and through bypass fluid path 112a, thereby bypassing anionic resin cartridge 130 in the “acid cleaning mode” (described in more detail in relation to FIG. 1B). For example, the control unit 160 may control valve arrangement 140 by opening the first valve 140a, closing the second valve 140b, and closing the third valve 140c. In some embodiments, the control unit 160 is configured to (iii) control valve arrangement 140 to selectively direct water to through bypass fluid path 112b, thereby bypassing cationic resin cartridge 120, to anionic resin cartridge 130 in the “alkaline cleaning mode” (described in more detail in relation to FIG. 1C). For example, the control unit 160 may control valve arrangement 140 by closing the first valve 140a, opening the second valve 140b, and closing the third valve 140c.

Referring now to FIG. 2, FIG. 2 illustrates another configuration for a water purification module 100b. Water purification module 100b (generally referred to as water purification module 100) may include many of the same features and components as water purification module 100a illustrated in FIGS. 1A, 1B and 1C. Also, the functionality described with reference to FIGS. 1A-1C is generally the same for the example in FIG. 2. For example, water purification module 100b includes a fluid path 110, a cationic resin cartridge 120 (e.g., strong cationic resin cartridge 120a and weak cationic resin cartridge 120b), anionic resin cartridge 130 (e.g., a strong anionic resin sub-cartridge 130a), one or more bypass fluid paths 112a,b, a valve arrangement 140, and a control unit 160. In some embodiments, the anionic resin cartridge 130 also comprises a weak cationic resin sub-cartridge 130b.

As noted in FIG. 2, bypass fluid path 112b and more specifically fluid line 114b may be optional, which is indicated by the dashed line for fluid line 114b. The inclusion of bypass fluid path 112b and fluid line 114b allows the water purification module 100b to perform alkaline cleaning. Conversely, if the optional fluid line 114b is not present, the water purification module 100b of FIG. 2 may perform acid cleaning or may generate pure water. Similarly, the bypass fluid path 112b and fluid line 114b may be optional for the examples illustrated in FIGS. 1A-1C.

Similarly, as noted in FIG. 2, bypass fluid path 112a and more specifically fluid line 114a may be optional, which is indicated by the dashed line for fluid line 114a. The inclusion of bypass fluid path 112a and fluid line 114a allows the water purification module 100b to perform acid cleaning. Conversely, if the optional fluid line 114a is not present, the water purification module 100b of FIG. 2 may perform alkaline cleaning or may generate pure water. Similarly, the bypass fluid path 112a and fluid line 114a may be optional for the examples illustrated in FIGS. 1A-1C.

However, water purification module 100b may additionally include mixed bed resin cartridge 150 in fluid communication with cationic resin cartridge 120 and anionic resin cartridge 130. Mixed bed resin cartridge 150 may include a combination of anion and cation resins. It should be appreciated that instead of mixed bed resin cartridge 150, water purification module 100b may instead include a polishing module 180 (see FIGS. 1A-1C). Polishing module 180 may include one or more of mixed bed resin cartridge 150 (similar to mixed bed resin cartridge 150 of FIG. 2), an electrodeionization (“EDI”) module, a continuous electrodeionization module (“CEDI”), a capacitive deionization (“CDI”) module, etc.

In the illustrated example, mixed bed resin cartridge 150 is arranged along a fluid line of flow path 110 downstream of resin cartridges 120, 130. Additionally, mixed bed resin cartridge 150 may be in series with cationic resin cartridge 120 and anionic resin cartridge 130.

As illustrated in FIG. 2, mixed bed resin cartridge 150 may be bypassed via bypass fluid path 112a. Specifically, feed water from source 101 may travel through cationic resin cartridge 120, through bypass fluid path 112a (e.g., fluid lines 114a and 114d) to bypass mixed bed resin cartridge 150 before arriving at exit 103. Bypassing the mixed bed resin cartridge 150 ensures that cleaning fluid (e.g., acid cleaning fluid or alkaline cleaning fluid) produced by the water purification module 100b can be delivered to the exit 103 without the H+ or OH− of the cleaning fluid being absorbed by the mixed bed resin cartridge 150.

For example, the bypass fluid path 112a may be arranged to bypass the mixed bed resin cartridge 150. In the illustrated example, fluid line 114d and valves 140d, 140e allow mixed bed resin cartridge 150 to be bypassed. As illustrated in FIG. 2, the fourth valve 140d is positioned in fluid line 114d, which is fluidly connected between the fifth point 118e and the second point 118b. The fifth valve(s) 140e is positioned downstream an outlet of the mixed bed resin cartridge 150 prior to reaching the fifth point 118e. By opening fourth valve 140d and closing fifth valve 140e, fluid exiting either the cationic resin cartridge 120 or the anionic resin cartridge 130 bypasses mixed bed resin cartridge by flowing along bypass fluid path 112a, through fluid line 114d and through open fourth valve 140d.

Other components of FIG. 2 are also depicted as optional. For example, everything within the dotted boundary 185 may be optional such that the fluid path extends from point 118b to the second sensor module 190b and then directly to exit 103. Specifically, with each component within the dotted boundary 185 removed, fluid may travel to the exit 103 without interacting with fourth valve 140d, mixed bed resin cartridge 150, fifth valve 140e or the third sensor module 190c.

In more detail, the example illustrated in FIG. 2 may be adapted to (1) perform acid cleaning or generate pure water or (2) perform alkaline cleaning or generate pure water. For example, in scenario (1), fluid line 114b is removed and therefore feed water may be passed through cationic resin cartridge 120 and then through fluid line 114a to bypass the anionic resin cartridge 130 to produce acid cleaning fluid. Additionally, in scenario (1), the water purifier 100b may also generate pure water by passing feed water through both the cationic resin cartridge 120 and the anionic resin cartridge 130. In scenario (2), fluid line 114a is removed and therefore feed water may be passed through only the anionic resin cartridge 130 (e.g., by bypassing cationic resin cartridge 120 via fluid line 114b) to produce alkaline cleaning fluid. Alternatively, in scenario (2), the water purifier 100b ay also generate pure water by passing feed water through both the cationic resin cartridge 120 and the anionic resin cartridge 130.

### Pre-Treatment and Polishing Modules

In an example, water purification module 100 may include a pre-treatment module 170. Pre-treatment module 170 may include one or more of a water softener, an active carbon filter, a particle filter, an ultraviolet sterilizer, or the like. Pre-treatment module 170 may be arranged upstream of resin cartridges 120, 130 and mixed bed resin cartridge (e.g., mixed bed resin cartridge 150 of FIG. 2). As illustrated in FIGS. 1A-1C, pre-treatment module 170 is positioned along fluid path 110, however the pre-treatment module 170 may optionally be positioned along a branch fluid path with associated valves, such that feed water from source 101 may pass through pre-treatment module 170 for treatment or bypass the pre-treatment module 170.

Additionally, water purification module 100 may include an optional flow restrictor 172. In the illustrated examples, flow restrictor 172 is positioned along the fluid path 110, upstream from cation resin cartridge 120 and anion resin cartridge 230, and downstream of pre-treatment module 170. Flow restrictor 172 is optional and may alternately be positioned upstream from pre-treatment module 170. In another example, flow restrictor 172 may be incorporated as part of pre-treatment module 170 or as part of a valve 115. The valve 115 is arranged upstream the cartridges 120, 130, and is configured to open and close the flow of feed water to the cartridges 120, 130. In the illustrated example, valve 115 is positioned between the pre-treatment module 170 and the flow restrictor 172, but it should be appreciated that the valve 115 may be arranged at any location along the fluid path that is upstream of both the cartridges 120, 130.

In an example, water purification module 100 may also include a polishing module 180. Polishing module 180 may include one or more of mixed bed resin cartridge 150 (similar to mixed bed resin cartridge 150 of FIG. 2), an electrodeionization (“EDI”) module, a continuous electrodeionization module (“CEDI”), a capacitive deionization (“CDI”) module, etc. The EDI module and CEDI module may be configured to utilize electricity, ion exchange membranes and resin to deionize water and separate dissolved ions (e.g., impurities) from the water. In an example, the EDI module may be used to demineralize, purify or otherwise treat the water. For example, the EDI module may purify water through a process that removes ionizable species from the water using electrically active media along with electricity (e.g., electric potential) to influence ion transport. An EDI module may include media that has a permanent charge or a temporary charge.

The CEDI module may rely on ion transport through electrically active media. Typically, the CEDI module may include both anion and cation selective membranes. The membranes may be semi-permeable and electrically active. The CEDI may regenerate the resin mass continuously with the electric current.

As noted above, the pre-treatment module 170 may include one or more of a water softener, an active carbon filter, a particle filter, an ultraviolet sterilizer, or the like. Some components of the pre-treatment module 170 may be arranged downstream from resin cartridges 120, 130 and mixed bed resin cartridge (e.g., mixed bed resin cartridge 150 of FIG. 2). It should be appreciated that if one or more of the components of the pre-treatment module 170 are positioned and arranged downstream from resin cartridges 120, 130, the components may provide “post-treatment” or “polishing” instead of “pre-treatment”. If a mixed bed resin cartridge 150 is already present in the system, the polishing module 180 may include an additional mixed bed resin cartridge, which may have a different chemistry than the mixed bed resin cartridge 150. Alternatively, the polishing module 180 may arranged for performing electrodeionization. As illustrated in FIGS. 1A-1C, polishing module 180 is positioned along fluid path 110, however the polishing module 180 may optionally be positioned along a branch fluid path with associated valves, such that water passing through one or more of the resin cartridges 120, 130 and 150 may pass through polishing module 180 for polishing or bypass the polishing module 180 all-together. It should be understood that the water purification module 100b in FIG. 2 may include any of the components as explained in connection with the water purification modules 100a of FIGS. 1A-1C, for example any of the pre-treatment module 170, the polishing module 180, valve 115 etc.

### Sensor Modules

Referring back to FIGS. 1A, 1B, 1C and 2, water purification module 100 may also include a sensor arrangement 190. The sensor arrangement 190 includes one or more sensor modules 190a, 190b, 190c. More specifically, referring to FIGS. 1A, 1B and 1C, the sensor arrangement 190 comprises a first sensor module 190a and a second sensor module 190b. However, in alternative embodiments, only one of the sensor modules 190a and 190b may be present. Sensor arrangement 190, and more specifically sensor module 190a, may include one or more of an upstream temperature sensor 192a, an upstream conductivity sensor 194a, and an upstream pH sensor 196a. Each of the upstream sensors (e.g., sensors 192a, 194a, 196a) may be positioned upstream of both the cationic resin cartridge 120 and the anionic resin cartridge 130. As illustrated in FIGS. 1A, 1B, 1C and FIG. 2, the upstream sensors (e.g., sensors 192a, 194a, 196a) form the first sensor module 190a. However, it should be appreciated that in alternative embodiments, the first sensor module 190a may include a different collection of upstream sensors. For example, the first sensor module 190a may only include the upstream temperature sensor 192a and the upstream conductivity sensor 194a. In another example, the first sensor module 190a may include other sensors in addition to sensors 192a, 194a, 196a. Even though the first sensor module 190a is illustrated downstream of pre-treatment module 170, the first sensor module 190a may instead be positioned upstream of the pre-treatment module 170 or at any other position along fluid path 110 between source 101 and point 118c.

As illustrated in the FIGS. 1A-1C and FIG. 2, temperature sensors may be denoted as “T1”, “T2” and “T3”; conductivity sensors may be denoted as “C1”, “C2” and “C3”; and pH sensors may be denoted as “pH1”, “pH2” and “pH3”.

The sensor arrangement 190 may also include a downstream temperature sensor 192b, a downstream conductivity sensor 194b, and a downstream pH sensor 196b. Each of the downstream sensors (e.g., sensors 192a, 194a, 196a) may be positioned downstream from resin cartridges 120, 130. As illustrated in FIGS. 1A, 1B, 1C and FIG. 2, the downstream sensors (e.g., sensors 192b, 194b, 196b) form the second sensor module 190b. However, it should be appreciated that in alternative embodiments, the second sensor module 190b may include a different collection of downstream sensors. For example, the second sensor module 190b may only include the downstream temperature sensor 192b and the downstream conductivity sensor 194b. In another example, the second sensor module 190b may include other sensors in addition to sensors 192b, 194b, 196b.

Referring to FIG. 2, water purification module 100 includes a sensor arrangement 190 comprising three sets of sensor modules, the first sensor module 190a, second sensor module 190b and third sensor module 190c. However, in alternative embodiments, the water purification module 100 may only comprise one or two of the first sensor module 190a, second sensor module 190b and third sensor module 190c. For example, in some embodiments the third sensor module 190c is not present.

In the example illustrated in FIG. 2, first sensor module 190a may include upstream sensors (e.g., upstream temperature sensor 192a, upstream conductivity sensor 194a and upstream pH sensor 196a). Second sensor module 190b is arranged such that the second sensor module 190b is used when directing fluid through the mixed bed resin cartridge 150. For example, if the mixed bed resin cartridge 150 is bypassed, fluid is unable to reach second sensor module 190b. Therefore, for the purposes of explanation, second sensor module 190b in FIG. 2 is described as including intermediate sensors (e.g., intermediate temperature sensor 192b, intermediate conductivity sensor 194b and intermediate pH sensor 196b). Additionally, the water purification module 100 in FIG. 2 may include third sensor module 190c with downstream sensors (e.g., downstream temperature sensor 192c, downstream conductivity sensor 194c and downstream pH sensor 196c). It should be appreciated that sensor modules 190b and 190c of FIG. 2 may also include pH sensors, similar to first sensor module 190a. Similarly, it should be appreciated that in alternative embodiments, the third sensor module 190c may include a different collection of downstream sensors. For example, the third sensor module 190c may include more sensors, less sensors, or other sensors in addition to those depicted in FIG. 2.

Water purification module 100 is configured to generate purified product water and one or more cleaning fluids and may obtain measurements or values of the corresponding generated fluids, the source feed water, or intermediate fluids existing in an intermediate production step (e.g., feed water passed through pre-treatment module 170 may be considered an intermediate fluid). The measurements or values may include temperature values, conductivity values, and pH values.

Through the sensor arrangement 190, water purification module 100 may measure upstream values (e.g., upstream temperature, conductivity and pH) of feed water or an intermediate fluid that has yet to pass through either of the cationic resin cartridge 120 and the anionic resin cartridge 130, but may have already passed through a pre-treatment module 170 or flow restrictor 172. Additionally, water purification module 100 may measure downstream values (e.g., downstream temperature, conductivity and pH) of cleaning fluids, product water or other intermediate fluids (e.g., purified water that has yet to pass through a polishing module 180).

Water purification module 100 may be configured to verify a property of the cleaning fluid (e.g., verify the potency, strength or suitability of the cleaning fluid to determine whether the cleaning fluid is suitable to perform its intended cleaning) based on at least one of a conductivity value or a pH value of one or more of the inlet feed water, the produced cleaning fluid, and the purified product water. Specifically, water purification module 100 may be configured to test one or more of: the conductivity of the inlet feed water with upstream conductivity sensor 194a, the pH value of the inlet feed water with upstream pH sensor 196a, the conductivity value of the cleaning fluid with downstream conductivity sensor 194b, and the conductivity value of the purified water with downstream conductivity sensor 194b.

Water purification module 100 may also be configured to verify the potency, strength or suitability of the cleaning fluid based on a comparison of the conductivity value of the inlet feed water with one or more inlet conductivity thresholds. In another example, verifying the potency, strength or suitability of the cleaning fluid may be based on a comparison of the measured pH value or a calculated pH value of the inlet feed water with one or more pH thresholds. The calculated pH value may be calculated from an ionic strength of the cleaning fluid that is based on the conductivity value of the cleaning fluid. The calculations described herein may be based first on a determination of which resins or cartridges are bypassed when generating the cleaning fluid(s). Additionally, verifying the potency, strength or suitability of the cleaning fluid may be based on a comparison of the conductivity value of the purified water with one or more purified water conductivity thresholds or a comparison of the conductivity value of the cleaning fluid with the conductivity value of the inlet water. In an example, the water purification module 100 may be configured to obtain or measure at least one of: a conductivity value of the inlet water, a pH value of the cleaning fluid, a conductivity value of the cleaning fluid, and a conductivity value of generated purified water after the cleaning fluid has been generated, using at least one sensor of the sensor arrangement 190.

The conductivity value of the purified product water should be low if the water purification process executes properly. For example, passing feed water through both the cationic resin cartridge 120 and the anionic resin cartridge 130 should remove most ions from the feed water, resulting in a low ion product water having a low conductivity.

Comparisons of conductivity values of cleaning fluids and the inlet feed water may be expressed as a performance ratio. For example, the water purification module 100 may calculate a performance ratio of a resin cartridge (e.g., cationic resin cartridge 120 and/or anionic resin cartridge 130) based, at least in part, on the conductivity measured from upstream conductivity sensor 194a and downstream conductivity sensor 194b. In one example, the performance ratio is based on downstream conductivity divided by upstream conductivity. Specifically, various performance ratio (“PR”) values may be determined by subtracting a ratio of downstream or “post” conductivity values and the upstream or “pre” conductivity values (e.g., downstream conductivity divided by upstream conductivity) from “1” and multiplying by “100” to obtain a percentage. For example, a performance ratio for fluid flowing through both the cationic resin cartridge 120 and the anionic resin cartridge is described by PRₙₒᵣₘ=1−(C_{ds}/Cᵤₛ), where “C_{ds}” represents a downstream or “post” conductivity value after the fluid passes through both resin cartridges 120, 130 and “Cᵤₛ” represents upstream or “pre” conductivity value for the fluid before the fluid passes through the resin cartridges 120, 130. As noted above, to obtain a percentage, PRₙₒᵣₘ as a percentage may be calculated as (1−(C_{ds}/Cᵤₛ))*100. Similarly, a performance ratio for fluid flowing through the cationic resin cartridge 120 (“PR_{cat}”) is represented by PR_{cat}=1−(C_{ds-cat}/C_{us-cat}) and a performance ratio for fluid flowing through the anionic resin cartridge 130 (“PRₐₙᵢ”) is represented by PRₐₙᵢ=1−(C_{ds-ani}/C_{us-cat}). Conversely, the performance ratio may be based on upstream conductivity divided by downstream conductivity. The performance ratio may be any of a purified water conductivity ratio (PRₙₒᵣₘ), an acid cleaning fluid conductivity ratio (PR_{cat}), and an alkaline cleaning fluid conductivity ratio (PRₐₙᵢ).

It should be appreciated that the performance ratio may be determined using weighting factors. Performance ratios may be ratios of values other than conductivity, such as pH. As noted above, water purification module 100 may be configured to compare the performance ratio to a threshold value, which may indicate whether a cleaning fluid has sufficient potency, strength or suitability. In an example, performance ratios below the threshold value may be unsuitable for cleaning, or may indicate that multiple passes with the cleaning fluid are required to achieve the desired level of cleaning. Specifically, the acid cleaning fluid may be compared to a threshold value or a threshold range such that the cleaning fluid is considered suitable or acceptable when the pH falls within the range of 2 to 3. Similarly, the alkaline cleaning fluid may be compared to a threshold value or a threshold range such that the cleaning fluid is considered suitable or acceptable when the pH falls within the range of 11 to 12.

In an example, water purification module 100 may be configured to provide an alert indicating a status of cationic resin cartridge 120 and/or anionic resin cartridge 130. The status may be related to the remaining life of the respective resin cartridge 120, 130. In an example, the remaining life is based on conductivity, ionic strength, and/or pH of a cleaning fluid or an intermediate fluid that has yet to pass through either of the cationic resin cartridge 120 and the anionic resin cartridge 130. Additionally, the status or the remaining life may be based on the calculated performance ratio.

In use, water purification module 100 may generate a cleaning fluid (e.g., acid cleaning fluid as described in FIG. 1B or alkaline cleaning fluid as described in FIG. 1C) and then may determine one or more of a conductivity value and an estimated pH value of the cleaning fluid. The estimated pH value of the cleaning fluid may be based on a conductivity and/or an ionic strength of the cleaning fluid. However, typically the estimated pH value is based on the ionic strength of the cleaning fluid. Additionally, the conductivity value may also be related to the ionic strength of the cleaning fluid.

The water purification module 100 may also be configured to evaluate a performance of the cationic resin cartridge 120 and the anionic resin cartridge 130. For example, evaluating performance of a resin cartridge 120, 130 may include checking or determining whether a resin cartridge 120, 130 is exhausted or not. The performance may be evaluated based (a) a comparison of the conductivity value of the purified water with one or more purified water thresholds, (b) a comparison of the measured pH value or a calculated pH value with one or more pH performance thresholds, and (c) a comparison of the conductivity value of the cleaning fluid or purified water with the conductivity value of the inlet feed water. In an example, the calculated pH value is calculated from an ionic strength of the cleaning fluid that is based on the conductivity value of the cleaning fluid.

The comparison in (b) above that results in a pH value that is too high or too low compared to a pH performance threshold may indicate that one or more of the resin cartridges 120, 130 is working improperly, perhaps because the resin cartridge(s) 120, 130 is exhausted or depleted. For example, the pH value may be too high if the cationic resin cartridge 120 is depleted. The pH value may be too low if the anionic resin cartridge 130 is depleted. Similarly, comparing a measured pH to a calculated pH may provide details on the performance of the resin cartridge(s) 120, 130. For example, if the measured pH differs from the calculated pH (e.g., the actual pH is an unexpected value), this may also indicate that the resin cartridges 120, 130 are working improperly (e.g., cartridges are exhausted). Each of the comparisons described above may be expressed as a performance ratio, but it should be appreciated that calculating a performance ratio is not required.

In an example, water purification module 100 may be configured to provide an alert indicative of a result of the verification and/or a result of the performance evaluations described above.

### Modes of Operation

FIGS. 1A, 1B and 1C illustrate various modes for the water purification module 100. For example, water purification module 100 may be configured to selectively generate (i) purified product water in a “water production mode” as illustrated in FIG. 1A, (ii) an acid cleaning fluid that is configured to remove scaling and perform acid cleaning in an “acid cleaning mode” as illustrated in FIG. 1B, and (iii) an alkaline cleaning fluid that is configured to remove fouling and/or biofilm(s) and that is further configured to perform alkaline cleaning in an “alkaline cleaning mode” as illustrated in FIG. 1C. Through the various modes of operation, the systems and methods disclosed herein may reduce water exposure and save resin capacity by exposing the feed water to either cationic or anionic resin (e.g., to create a respective cleaning fluid). For example, the systems and methods disclosed herein advantageously reduce water consumption by approximately one-sixth (⅙) of the total purified water consumption and therefore provide the capability of increased purified water volume compared to similarly sized systems. For example, by balancing the resin cartridge(s) 120, 130 (e.g., instead of using resin cartridges that are of equal size ultimately leading to an unbalanced system) the water purification module 100 may generate more water before the resin cartridges are depleted.

As illustrated in FIG. 1A, in “water production mode” valves 115 and 140c are open while valves 140a and 140b are closed. In “water production mode” illustrated in FIG. 1A, feed water travels from source 101, optionally through a pre-treatment module 170, and continues along the fluid path 110. While traveling along the fluid path 110, the feed water passes through open valve 115, optionally through flow restrictor 172, to the cationic resin cartridge 120. After passing through the cationic resin cartridge 120, the water passes through open valve 140c and through fluid line 114c to the anionic resin cartridge 130. After exiting the anionic resin cartridge 130, the purified water may continue along the fluid path 110 to the exit 103 where the purified or product water exits the system. In an example, after passing through the anionic resin cartridge 130, the water may be treated by polishing module 180 before arriving at exit 103.

The purified product water may be used for hemodialysis (“HD”), peritoneal dialysis (“PD”) solution mixing, intensive care (“IC”) procedures (e.g., cleaning instruments and flushing wounds), large water based medical device and drug treatments, flushing of Ultra filters, flushing flow path(s) that have been exposed to patient effluent as well as flushing flow path(s) that have been exposed to different kinds of disinfection (e.g., heat disinfection).

As illustrated in FIG. 1B, in “acid cleaning mode” valves 115 and 140a are open while valves 140b and 140c are closed. In “acid cleaning mode” illustrated in FIG. 1B, feed water travels from source 101, optionally through a pre-treatment module 170, and continues along the fluid path 110. While traveling along the fluid path 110, the feed water passes through open valve 115, optionally through flow restrictor 172, to the cationic resin cartridge 120. After passing through the cationic resin cartridge 120, the generated acid cleaning fluid travels through bypass fluid path 112a and through open valve 140a thereby bypassing anionic resin cartridge 130. Then, the generated acid cleaning fluid travels through fluid line 114a continuing along the fluid path 110 to the exit 103. In the illustrated example, the acid cleaning fluid may perform cleaning operations on the fluid path once it exits the cationic resin cartridge 120. Additionally, once the acid cleaning fluid exits the system, it may be used to clean other devices the water purification module 100 is connected to. In an example, the acid cleaning fluid may optionally be treated by polishing module 180 before arriving at exit 103.

As illustrated in FIG. 1C, in “alkaline cleaning mode” valves 115 and 140b are open while valves 140a and 140c are closed. In “alkaline cleaning mode” illustrated in FIG. 1C, feed water travels from source 101, optionally through a pre-treatment module 170, and continues along the fluid path 110. While traveling along the fluid path 110, the feed water passes through open valve 115, optionally through flow restrictor 172. Then the feed water travels through bypass fluid path 112b and through open valve 140b as well as fluid line 114b to the anionic resin cartridge 130 thereby bypassing cationic resin cartridge 120. After passing through the anionic resin cartridge 130, the generated alkaline cleaning fluid continues along the fluid path 110 to the exit 103. In the illustrated example, the alkaline cleaning fluid may perform cleaning operations on the fluid path 110 once it exits the anionic resin cartridge 120. Additionally, once the alkaline cleaning fluid exits the system, it may be used to clean other devices the water purification module 100 is connected to. In an example, the alkaline cleaning fluid may optionally be treated by polishing module 180 before arriving at exit 103.

In “acid cleaning mode” the water purification module 100 may advantageously maintain flow paths in bacteriostatic conditions by filling the flow paths with the acid cleaning solution. Furthermore, the systems and methods disclosed herein may prevent failure of conductivity cells' (e.g., conductivity sensors 194b) electrodes that often occurs due to exposure of pure product water with low ion content.

Referring now to FIG. 2, water purification module 100b may generate purified water in the “water production mode”, acid cleaning fluid in the “acid cleaning mode”, and alkaline cleaning fluid in the “alkaline cleaning mode” in a similar fashion as described above with respect to FIGS. 1A, 1B and 1C. However, the purified water may also either be (1) passed to mixed bed resin cartridge 150 for additional processing or (2) passed through fluid line 114d and open valve 140d to bypass the mixed bed resin cartridge 150. Regardless of the type of fluid (e.g., purified water or cleaning fluid) generated prior to point 118b, once the fluid is at point 118b, the fluid may either travel to mixed bed resin cartridge 150 or bypass the mixed bed resin cartridge 150. Typically, the cleaning fluid will bypass the mixed bed resin cartridge 150 to avoid prematurely exhausting the resin(s) of the mixed bed resin cartridge 150 and to avoid further altering the pH of the cleaning solution.

In order to travel to mixed bed resin cartridge 150, valve 140d is closed and valve 140e is open thereby allowing the fluid to travel from point 118b, through mixed bed resin cartridge 150 and through open valve 140e to point 118e. Conversely, in order to bypass mixed bed resin cartridge, valve 140d is open while valve 140e is closed thereby enabling the fluid to travel from point 118e, through open valve 140d and to point 118e before arriving at exit 103.

The generated cleaning fluids are configured to clean a portion of the fluid path 110 that is downstream of both cationic resin cartridge 120 and anionic resin cartridge 130. The flow rate and volume of cleaning fluid generated may determine the duration of cleaning. In some instances, the water purification module 100 is configured to generate cleaning fluid to accommodate a specified duration. The duration may be a predetermined duration or a calculated duration such that the cleaning fluid has adequate time to clean the fouling, scaling and/or biofilm(s) from various components of the water purification module 100 (e.g., filters, membranes, fluid lines, etc.).

In an example, the specified duration is based on a result of the verification discussed above in “SENSOR MODULES”. For example, the verification may be based conductivity value(s) and/or pH value(s) of the cleaning fluid.

### Solution Generation

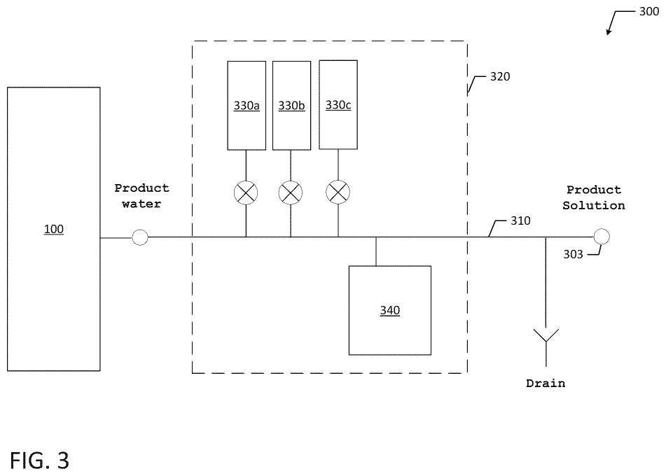

FIG. 3 illustrates an example solution generation system 300. The solution generation system 300 may include a water purification module 100. Water purification module 100 may be configured and arranged according to any of the examples described herein with respect to FIGS. 1A, 1B, 1C or FIG. 2. Solution generation system 300 may also include a solution generation module 320, which may include fluid path 310 fluidly connected to a corresponding fluid path 110 of water purification module 100.

In an example, solution generation module 320 is configured and arranged to receive purified water (e.g., product water) from water purification module 100 and prepare a solution (e.g., product solution) by mixing a concentrate(s) 330a, 330b, and/or 330c and the purified water. Additionally, solution generation module 320 may include batch container 340 for storing prepared solutions.

Similar to the cleaning operations discussed above with reference to FIGS. 1A, 1B, 1C and FIG. 2, water purification module 100 may similarly be configured to provide a cleaning fluid to fluid path 310 for cleaning the fluid path 310. The cleaning fluid may be emptied to a drain or sent to an exit or output connector 303.

### Methods

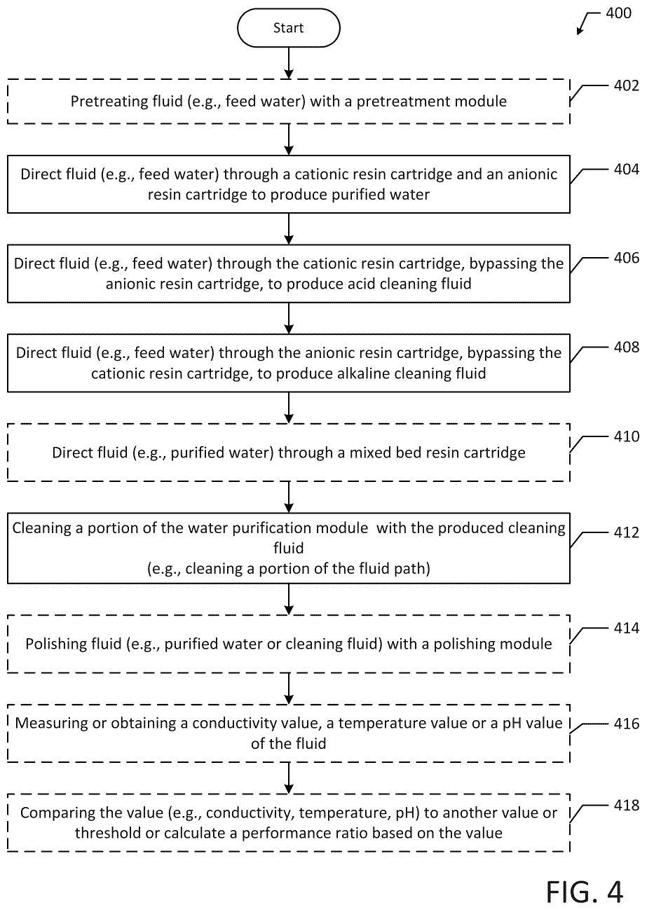

FIG. 4 illustrates a flowchart of an example method 400 for generating at least one of purified water, an acid cleaning fluid, and an alkaline cleaning fluid with a water purification module according to an example of the present disclosure. Although the example method 400 is described with reference to the flowchart illustrated in FIG. 4, it will be appreciated that many other methods of performing the acts associated with the method 400 may be used. For example, the order of some of the blocks may be changed, certain blocks may be combined with other blocks, one or more blocks may be repeated, and some of the blocks described may be optional. The method 400 may be performed by processing logic that may comprise hardware (circuitry, dedicated logic, etc.), software, or a combination of both. For example, method 400 may be performed by water purification module 100 or its corresponding control unit 160.

The example method 400 includes optionally pretreating fluid (e.g., feed water) with a pretreatment module 170 (block 402). The pretreatment module 170 may include any of a water softener, an active carbon filter, a particle filter, an ultraviolet sterilizer or a combination thereof. The water softener may be a resin-based softener or a non-resin-based softener. In an example, where the softener is positioned upstream of the ion exchange water purifier, the softener is a non-resin-based softener as ion exchange resins are already present downstream of the pretreatment module 170 (e.g., cationic resin cartridge 120 and anionic resin cartridge 130). Method 400 may also include directing fluid (e.g., feed water) through a cationic resin cartridge 120 and the anionic resin cartridge 130 to produce purified water (block 404). For example, when water purification module 100 is in “water production mode” as illustrated in FIG. 1A, control unit 160 may selectively control various vales of valve arrangement 140 to direct feed water through cationic resin cartridge 120 and anionic resin cartridge 130 to produce purified product water. Specifically, the control unit 160 may control valve arrangement 140 by closing the first valve 140a, closing the second valve 140b, and opening the third valve 140c to produce purifier water in the “water production mode”.

Additionally, method 400 may include directing fluid (e.g., feed water) through the cationic resin cartridge 120, thereby bypassing the anionic resin cartridge 130, to produce an acid cleaning fluid (bock 406). For example, when water purification module 100 is in “acid cleaning mode” as illustrated in FIG. 1B, control unit 160 may selectively control various valves of valve arrangement 140 to direct feed water through cationic resin cartridge 120 and through bypass fluid path 112a, thereby bypassing anionic resin cartridge 130 to produce acid cleaning fluid. The acid cleaning fluid is configured to remove scaling and other inorganic precipitation and perform acid cleaning on various components of water purification module 100 (e.g., filters, membranes, and water lines). Specifically, the control unit 160 may control valve arrangement 140 by opening the first valve 140a, closing the second valve 140b, and closing the third valve 140c to produce acid cleaning fluid in the “acid cleaning mode”.

Method 400 may include directing fluid (e.g., feed water) through the anionic resin cartridge 130, thereby bypassing the cationic resin cartridge 120, to produce an alkaline cleaning fluid (block 408). For example, when water purification module 100 is in “alkaline cleaning mode” as illustrated in FIG. 1C, control unit 160 may selectively control various vales of valve arrangement 140 to direct feed water through bypass fluid path 112b, thereby bypassing cationic resin cartridge 130 and directing the feed water to the anionic resin cartridge 130 to produce alkaline cleaning fluid. The alkaline cleaning fluid is composed to remove fouling, fats, and protein biofilm(s) to perform alkaline cleaning and perform acid cleaning on various components of water purification module 100 (e.g., filters, membranes, and water lines). Specifically, the control unit 160 may control valve arrangement 140 by closing the first valve 140a, opening the second valve 140b, and closing the third valve 140c to produce alkaline cleaning fluid in the “alkaline cleaning mode”.

Method 400 may optionally include directing fluid (e.g., purified water from block 404) through a mixed bed resin cartridge 150 (block 410). For example, the mixed bed resin cartridge 150 may further purify the purified water generated at block 404.

When the water purification module 100 is ready to be cleaned, method 400 includes cleaning a portion of the water purification module 100 (e.g., a portion of fluid path 110) with the cleaning fluid produced at blocks 406, 408 (block 412). For example, any portion of the fluid path that is downstream of the cationic resin cartridge 120 and anionic resin cartridge 130 may be cleaned by a cleaning fluid produced by water purification module 100. Cleaning may occur on a predetermined schedule to maintain various parts and/or components of the water purification module 100 in working order by routinely removing scaling, fouling, biofilms, etc.

Method 400 may also optionally include polishing fluid (e.g., purified water from block 404 or a cleaning fluid from blocks 406, 408) with a polishing module 180 (block 414). The polishing module 180 may include a mixed bed resin cartridge 150, an electrodeionization (EDI) module, a continuous electrodeionization module (CEDI), a fluid membrane or a combination thereof.

Method 400 may also include measuring or obtaining a conductivity value, a temperature value, a pH value or a combination thereof of the fluid (block 416). For example, as discussed above with respect to FIGS. 1A, 1B, 1C and FIG. 2, various upstream and downstream conductivity and pH values may be updated by upstream and downstream conductivity sensors 194a, 194b and pH sensors 196a, 196b. Furthermore, water purification module may calculate or estimate conductivity and pH values. The conductivity and pH values may relate to feed water, cleaning fluids, or purified product water.

Then, method 400 optionally includes comparing the value(s) to another value(s) (e.g., another measured value, another calculated value, or another threshold value) and/or calculating a performance ratio based on the value (block 418). For example, comparisons between pH values that result in a pH value that is too high or too low compared to a pH performance threshold may indicate that one or more of the resin cartridges 120, 130 is working improperly, perhaps because the resin cartridge(s) 120, 130 is exhausted or depleted. Comparisons may be expressed as a performance ratio. Additionally, a remaining life may be determined, which is based on conductivity, ionic strength, and/or pH of a cleaning fluid or an intermediate fluid that has yet to pass through either of the cationic resin cartridge 120 and the anionic resin cartridge 130. Additionally, the status or the remaining life may be based on the calculated performance ratio.

It should be understood that various changes and modifications to the presently preferred embodiments described herein will be apparent to those skilled in the art. It is therefore intended that such changes and modifications are covered by the appended claims.

1-33: (canceled)

34: A water purification module comprising:
a fluid path including:
a cationic resin cartridge,
an anionic resin cartridge, wherein the anionic resin cartridge is fluidly connected in series with the cationic resin cartridge,
at least one bypass fluid path including a first bypass fluid path arranged to bypass the anionic resin cartridge while allowing water to flow to the cationic resin cartridge, and
a valve arrangement comprising one or more valves configured to selectively direct water to the at least one bypass fluid path; and
a control unit configured to control the valve arrangement to direct water through the at least one bypass fluid path based on a production mode of the water purification module, wherein the production mode is one of (i) a water production mode wherein the water purification module is configured to generate purified water, and (ii) an acid cleaning mode where the water purification module is configured to selectively generate an acid cleaning fluid adapted to remove scaling and perform acid cleaning,
wherein the control unit is configured to control the valve arrangement to direct water to both the cationic resin cartridge and the anionic resin cartridge in the water production mode, and to selectively control the valve arrangement to direct water through the cationic resin cartridge and through the first bypass fluid path to bypass the anionic resin cartridge in the acid cleaning mode.

35: The water purification module of claim 34, wherein the at least one bypass fluid path includes a second bypass fluid path arranged to bypass the cationic resin cartridge while allowing water to flow to the anionic resin cartridge.

36: The water purification module of claim 35, wherein the production mode additionally includes (iii) an alkaline cleaning mode where the water purification module is configured to selectively generate an alkaline cleaning fluid that is adapted to remove at least one of fouling and a biofilm and that is further adapted to perform alkaline cleaning.

37: The water purification module of claim 34, wherein the valve arrangement is configured to selectively direct water to the first bypass fluid path of the at least one bypass fluid path.

38: The water purification module of claim 34, wherein the first bypass fluid path comprises a first fluid line fluidly connected between a first point and a second point, wherein the first point is downstream from the cationic resin cartridge and upstream from the anionic resin cartridge, and wherein the second point is downstream of the anionic resin cartridge.

39: The water purification module of claim 38, wherein the valve arrangement comprises one or more first valves arranged along the first fluid line.

40: The water purification module of claim 35, wherein the valve arrangement is configured to selectively direct water to the second bypass fluid path instead of the first bypass fluid path.

41: The water purification module of claim 36, wherein the control unit is configured to control the valve arrangement to selectively direct water through the second bypass fluid path to bypass the cationic resin cartridge and through the anionic resin cartridge in the alkaline cleaning mode.

42: The water purification module of claim 35, wherein the second bypass fluid path comprises a second fluid line fluidly connected between a third point and a fourth point, wherein the third point is upstream from both the cationic resin cartridge and the anionic resin cartridge, and wherein the fourth point is downstream of the cationic resin cartridge and upstream from the anionic resin cartridge.

43: The water purification module of claim 42, wherein the valve arrangement comprises one or more second valves arranged along the second fluid line.

44: The water purification module of claim 35, wherein the fluid path comprises a third fluid line connecting an output port of the cationic resin cartridge to an input port of the anionic resin cartridge.

45: The water purification module of claim 44, wherein the valve arrangement comprises one or more third valves arranged to stop water flow in the third fluid line while water is directed to the first bypass fluid path.

46: The water purification module of claim 34, wherein the fluid path comprises a mixed bed resin cartridge in fluid communication with the cationic resin cartridge and the anionic resin cartridge.

47: The water purification module of claim 46, wherein the mixed bed resin cartridge is arranged downstream and in series with the cationic resin cartridge and the anionic resin cartridge.

48: The water purification module of claim 47, wherein the first bypass fluid path is arranged to bypass the mixed bed resin cartridge.

49: The water purification module of claim 46, wherein the first bypass fluid path comprises a fourth fluid line fluidly connected between a fifth point and a second point, wherein the fifth point is downstream of each of the cationic resin cartridge, the anionic resin cartridge and the mixed bed resin cartridge, and wherein the second point is downstream of the anionic resin cartridge and upstream from the mixed bed resin cartridge.

50: The water purification module of claim 46, wherein the mixed bed resin cartridge includes a combination of anion and cation resins.

51: The water purification module of claim 34, wherein the water purification module is configured and arranged to produce a cleaning fluid and clean a portion of the fluid path, that is downstream of both the cationic resin cartridge and the anionic resin cartridge, using the cleaning fluid.

52: A solution generation system comprising:
a water purification module including:
a fluid path comprising:
a cationic resin cartridge,
an anionic resin cartridge, wherein the anionic resin cartridge is fluidly connected in series with the cationic resin cartridge,
at least one bypass fluid path including a first bypass fluid path arranged to bypass the anionic resin cartridge while allowing water to flow to the cationic resin cartridge, and
a valve arrangement comprising one or more valves configured to selectively direct water to the at least one bypass fluid path; and
a control unit configured to control the valve arrangement to direct water through the at least one bypass fluid path based on a production mode of the water purification module, wherein the production mode is one of (i) a water production mode wherein the water purification module is configured to generate purified water, and (ii) an acid cleaning mode where the water purification module is configured to selectively generate an acid cleaning fluid adapted to remove scaling and perform acid cleaning, wherein the control unit is configured to control the valve arrangement to direct water to both the cationic resin cartridge and the anionic resin cartridge in the water production mode, and to selectively control the valve arrangement to direct water through the cationic resin cartridge and through the first bypass fluid path to bypass the anionic resin cartridge in the acid cleaning mode; and
a solution generation module comprising another fluid path fluidly connected to the fluid path of the water purification module, wherein the solution generation module is configured and arranged to:
receive purified water from the water purification module, and
prepare a solution by mixing a concentrate and the purified water.

53: A method for producing a cleaning fluid with a water purification module arranged for producing purified water, the water purification module comprising:
a cationic resin cartridge and an anionic resin cartridge positioned along a fluid path, wherein the anionic resin cartridge is fluidly connected in series with the cationic resin cartridge, and
at least one bypass fluid path including a first bypass fluid path arranged to bypass the anionic resin cartridge while allowing water to flow to the cationic resin cartridge,
wherein the method comprises:
directing water through the at least one bypass fluid path based on a production mode of the water purification module, wherein the production mode is one of (i) a water production mode for generating purified water, and (ii) an acid cleaning mode for selectively generating an acid cleaning fluid adapted to remove scaling and perform acid cleaning, wherein the water production mode comprises directing water to both the cationic resin cartridge and the anionic resin cartridge, and the acid cleaning mode comprises directing water through the cationic resin cartridge and through the first bypass fluid path to bypass the anionic resin cartridge.
